(19) United States
(12) Patent Application Publication
(10) Pub. No.: US 2014/0097309 A1
(43) Pub. Date: Apr. 10, 2014

(54) LEG DEVICE IN MUSICAL INSTRUMENT STAND, MUSICAL INSTRUMENT STAND INCLUDING THE LEG DEVICE, AND SUPPORT FITTING FOR USE IN THE LEG DEVICE

(71) Applicant: SAKAE RHYTHM MUSICAL INSTRUMENT LTD., Osaka-shi (JP)

(72) Inventors: Eizo NAKATA, Osaka-shi (JP); Shunsaku TSUJI, Tondabayashi-shi (JP); Takashi WARIISHI, Osaka-shi (JP); Manabu MORIOKA, Nara-shi (JP)

(73) Assignee: SAKAE RHYTHM MUSICAL INSTRUMENT LTD., Osaka-shi (JP)

(21) Appl. No.: 14/050,916

(22) Filed: Oct. 10, 2013

(30) Foreign Application Priority Data
Oct. 10, 2012 (JP) 2012-225111
Apr. 18, 2013 (JP) 2013-087183

(51) Int. Cl. G10G 5/00

(52) U.S. Cl. CPC G10G 5/00
USPC 248/166

(57) ABSTRACT

To provide a leg device in a musical instrument stand that is further adjustable on setting of the musical instrument to avoid stand legs from being an impediment to the setting and avoid a stand main body from being unstable even if two stand legs are provided.

### TECHNICAL FIELD

The present invention relates to a leg device in a musical instrument stand preferably suited to a high-hat stand for playing cymbals and the like.

### BACKGROUND ART

For example, in a high-hat stand, a stand main body is supported by two or more stand legs and a pedal frame, and each of the stand legs is foldably attached to the stand main body via a support fitting. The stand legs are arranged at three places around the stand main body at approximately regular angular intervals (120°) to support the stand main body in a stable state together with the pedal frame among the stand legs.

However, since the pedal is arranged among the three stand legs at intervals of 120°, there is a problem that, when a user operates the pedal, his or her legs hit against the stand legs due to congestion around the pedal, and especially, when plural musical instruments are played, the stand legs interfere with the setting of the musical instruments. In particular, when plural musical instruments including a bass drum and a snare drum are set on a high-hat stand so as to be adjacent to each other, these musical instruments cannot be close to each other with the stand legs in the way.

Meanwhile, there have been provided high-hat stands with two stand legs to reduce congestion (for example, refer to Patent Documents 1 and 2) and high-hat stands configured such that support fittings for attachment of stand legs are made capable of turning in the horizontal direction around the axis of the stand main body together with the stand legs whereby it is possible to avoid the stand legs from being in the way of setting musical instruments or adjust the stand legs to desired positions at which it is unlikely that user's legs hit against the stand legs, by turning the entire stand legs in the horizontal direction (for example, refer to Patent Documents 3 and 4).

However, even if the number of stand legs is decreased to two, when the stand legs are placed at fixed positions, the stand legs cannot be adjusted but may be an impediment to setting of musical instruments. In addition, if the stand legs are turned from side to side together with the support fittings to avoid the stand legs from being in the way of setting of musical instruments, the stand legs may be relatively adjustable as compared to the case where the stand legs are placed at fixed positions. However, the stand legs are still not sufficiently adjustable but may be an impediment even when being turned in any manner. Further, when the two stand legs are turned from side to side together with the support fittings, there is the possibility that the stand main body becomes unstable in positional relationship with the pedal frame.

### CITATION LIST

### Patent Literatures

Patent Document 1: JP-UM-A No. S53-101533
Patent Document 2: JP-A No. H11-95744
Patent Document 3: JP-A No. H10-232670
Patent Document 4: JP-A No. 2001-109466

### SUMMARY OF INVENTION

### Technical Problem

In light of the foregoing circumferences, an object of the present invention is to provide a leg device in a musical instrument stand, a musical instrument stand including the leg device, and a support fitting for use in the leg device that are further adjustable on setting of the musical instrument to avoid stand legs from being an impediment to the setting and avoid a stand main body from being unstable even if the number of stand legs are two, for example.

To solve the foregoing issue, the present invention constitutes a leg device in a musical instrument stand including two or more stand legs extended from a stand main body to a floor surface and support fittings that attach the stand legs to the stand main body so as to be foldable, and supporting the stand main body together with a pedal device connected to a lower end of the stand main body, wherein the support fittings each include: a support fitting main body attached to an outer peripheral surface of the stand main body so as to be capable of turning from side to side around an axis of the stand main body; and a connection member having one end portion pivotally attached to an outer peripheral part of the support fitting main body so as to be capable of turning from side to side around an axis parallel to the axis of the stand main body and having a bearing part at the other end portion thereof to which an end portion of the stand leg is pivotally attached so as to be capable of turning up and down around an axis orthogonal to the axis of the stand main body, and wherein a turning angle of the support fitting main body with respect to the stand main body and a turning angle of the connection member with respect to the support fitting main body are adjusted, thereby to allow adjustments of both side-to-side turning positions of the stand legs pivotally attached to the connection member around the axis of the stand main body and side-to-side turning angles of the stand legs around the axis of the outer peripheral part of the support fitting main body.

It is preferred that the support fitting main body include: at an outer peripheral part thereof a bearing part supporting a shaft part provided at the one end part of the connection member and extended parallel to the axis of the stand main body so as to be capable of turning from side to side, and a support member with a screw hole penetrating an inner peripheral surface side toward an axial center of the stand main body; a fastening screw that is screwed into the screw hole in the support member and has a penetrating screw tip end pressing the outer peripheral surface of the stand main body directly or via the press member; and a stopper member that has a bearing part opposed to the bearing part of the support member and receiving and supporting the shaft part of the connection member so as to be capable of turning from side to side together with the bearing part of the support member and has a stopper part at least in a position opposite to the fastening screw with respect to the stand main body to abut and stop on the outer peripheral surface of the stand main body directly or via the press member, and wherein, when the fastening screw is fastened to press the outer peripheral surface of the stand main body, the support member moves in a direction toward the fastening screw and the bearing part of the support member draws the shaft part of the connection member in that direction, and at the same time, the bearing part of the stopper member supporting the shaft part is also drawn in that direction and the stopper part abuts and stops on the outer peripheral surface of the stand main body directly or via the press member, whereby the shaft part is fixed so as to be incapable of turning by a drawing force of the support member acting on the shaft part and a resistive force of the stopper member in the opposite direction, and a pressing force of the fastening screw tip end and a stopping force of the stopper part of the stopper member act on the outer peripheral surface of the stand main body directly or via the press member, whereby the support fitting main body is fixed so as to be incapable of turning.

It is in particular preferred that the support fitting main body is attached to the outer peripheral surface of the stand main body so as to be slidable in an axial direction, and when the fastening screw is fastened to press the outer peripheral surface of the stand main body, the support fitting main body is fixed so as to be incapable of rotating and fixed so as to be incapable of sliding in the axial direction.

It is also preferred that the stand leg includes a support leg that has a lower end placed on the floor surface and an upper end attached to the stand main body, and a connecting stay that has one end connected to a middle part of the support leg and the other end attached to the stand main body at a position lower than the upper end of the support leg, the support fittings are provided at two places along the axial direction of the stand main body, and of these support fittings, an upper first support fitting is slidable along the axial direction of the stand main body, the support leg is attached to the first support fitting, the connecting stay is attached to a lower second support fitting, and when the first support fitting is slid upward, the stand legs enter into a folded posture along the stand main body.

The present invention also constitutes a leg device in a musical instrument stand including two or more stand legs extended from a stand main body to a floor surface and support fittings that attach the stand legs to the stand main body so as to be foldable, and supporting the stand main body together with a pedal device connected to a lower end of the stand main body, wherein the support fittings each include: two or more concentric support members that are attached to the outer periphery of the stand main body so as to be capable of turning from side to side around the axis of the stand main body and have at an outer peripheral parts thereof bearing parts to which end parts of the stand legs are pivotally attached so as to be capable of turning up and down around an axis orthogonal to the axis of the stand main body; and a fixing means that, by fastening the fastening screw screwed into one support member of the support members or a fixing member other than the support members, presses or draws the support members in the axis direction of the fastening screw so as to abut and stop on the outer peripheral surface of the stand main body, thereby to fix the fixing members so as to be incapable of turning, wherein turning angles of the support members with respect to the stand main body are adjusted to allow adjustments of side-to-side turning positions of the stand legs pivotally attached to the support members around the axis of the stand main body.

It is preferred that, as the fixing member, a member having an annular exterior part to be externally attached to the stand main body is provided, and by fastening the fastening screw, the fixing member is drawn or pressed in a direction opposite to the support member along the axial direction of the fastening screw so as to abut and stop on the outer peripheral surface of the stand main body, thereby to fix the fixing member so as to be incapable of turning.

It is in particular preferred that the fixing member includes the exterior part and a female screw part to which the fastening screw is screwed, the two or more support members are concentrically arranged adjacent to the exterior part of the fixing member, and by fastening the fastening screw screwed into the female screw part, the fastening screw presses the outer peripheral surfaces of the support members directly or via another member, whereby the support members are pressed on the outer peripheral surface of the stand main body and fixed so as to be incapable of turning, the fixing member moves in a direction toward a base end of the fastening screw with an operation part, and the exterior part is drawn in that direction and abuts and stops on the outer peripheral surface of the stand main body directly or via another member, whereby the fixing member is fixed so as to be incapable of turning with respect to the stand main body.

It is further preferred that the female screw part is provided in a penetrating state, and by fastening the fastening screw screwed into the female screw part, a screw tip end part of the fastening screw protruding from the female screw part toward the stand main body presses the outer peripheral surfaces of the support members directly or via another member, whereby the support members are pressed on the peripheral surface of the stand main body and fixed so as to be incapable of turning, and the fixing member moves in the direction toward the base end of the fastening screw, and the exterior part is drawn in that direction and abuts and stops on the outer peripheral surface of the stand main body directly or via another member.

More specifically, it is preferred that the fixing member is almost three-side square-shaped in a vertical cross-sectional view and has a pair of upper and lower annular exterior parts externally attached to the stand main body and a connection part at which the exterior parts are connected and integrated with a space opened in the axial direction on the outside of the stand main body, the connection part being provided with the female screw part, the two or more support members are concentrically arranged in the space between the exterior parts of the fixing member, and by fastening the fastening screw screwed into the female screw part, the screw tip end part of the fastening screw protruding from the female screw part toward the stand main body presses the outer peripheral surfaces of the support members directly or via another member, whereby the support members are pressed against the outer peripheral surfaces of the stand main body and fixed so as to be incapable of turning, and the fixing member moves in the direction toward the base end of the fastening screw, and the exterior parts are drawn in that direction and abut and stop on the outer peripheral surface of the stand main body directly or via another member.

It is also preferred that the exterior parts of the fixing member are provided so as to be slidable in the axial direction with respect to the stand main body, and by fastening the fastening screw, the fixing member is drawn or pressed in the opposite direction of the support members along the axial direction of the fastening screw and abuts and stops on the outer peripheral surface of the stand main body, whereby the fixing member is fixed so as to be incapable of turning and incapable of sliding in the axial direction.

It is also preferred that the stand leg includes a support leg that has a lower end placed on the floor surface and an upper end attached to the stand main body and a connecting stay that has one end connected to a middle part of the support leg and the other end attached to the stand main body at a position lower than the upper end of the support leg, the support fittings are provided at two places along the axial direction of the stand main body, and of the support fittings, an upper first support fitting is slidable in the axial direction of the stand main body, the support leg is attached to the first support fitting, the connecting stay is attached to a lower second support fitting, and when the first support fitting is slid upward, the stand leg enters into a folded posture along the stand main body.

The present invention also provides a musical instrument stand including the foregoing leg device.

The present invention also provides a support fitting for use in the foregoing leg device including the support fitting main body and the connection member, wherein the turning angle of the support fitting main body with respect to the stand main body and the turning angle of the connection member with respect to the support fitting main body are adjusted to allow adjustments of both the side-to-side turning positions of the stand legs pivotally attached to the connection members around the axis of the stand main body and the side-to-side turning angle of the support fitting main body around the axis at the outer peripheral part.

The present invention also provides a support fitting for use in the foregoing leg device including the two or more concentric support members and the foregoing fixing means, wherein the turning angles of the support members with respect to the stand main body are adjusted to allow adjustments of the side-to-side positions of the stand legs pivotally attached to the support members around the axis of the stand main body.

According to the thus configured invention of the subject application, the support fittings each include: the support fitting main body attached to the outer peripheral surface of the stand main body so as to be capable of turning from side to side around the axis of the stand main body; and the connection member having one end portion pivotally attached to the outer peripheral part of the support fitting main body so as to be capable of turning from side to side around the axis parallel to the axis of the stand main body and having the bearing part at the other end portion thereof to which the end portion of the stand leg is pivotally attached so as to be capable of turning up and down around the axis orthogonal to the axis of the stand main body, and the turning angle of the support fitting main body with respect to the stand main body and the turning angle of the connection member with respect to the support fitting main body are adjusted, thereby to allow adjustments of both side-to-side turning positions of the stand legs pivotally attached to the connection member around the axis of the stand main body and side-to-side turning angles of the stand legs around the axis of the outer peripheral part of the support fitting main body, and thus the invention of the subject application makes it possible to allow further adjustments of the positions of the stand legs at setting of a musical instrument to avoid from being an impediment to the setting and avoid the stand main body from being unstable even if the number of stand legs are two.

The support fitting main body include: at the outer peripheral part thereof the bearing part supporting the shaft part provided at the one end part of the connection member and extended parallel to the axis of the stand main body so as to be capable of turning from side to side, and the support member with the screw hole penetrating the inner peripheral surface side toward the axial center of the stand main body; the fastening screw that is screwed into the screw hole in the support member and has the penetrating screw tip end pressing the outer peripheral surface of the stand main body directly or via the press member; and the stopper member that has the bearing part opposed to the bearing part of the support member and receiving and supporting the shaft part of the connection member so as to be capable of turning from side to side together with the bearing part of the support member and has the stopper part at least in the position opposite to the fastening screw with respect to the stand main body to abut and stop on the outer peripheral surface of the stand main body directly or via the press member, and wherein, when the fastening screw is fastened to press the outer peripheral surface of the stand main body, the support member moves in a direction toward the fastening screw and the bearing part of the support member draws the shaft part of the connection member in that direction, and at the same time, the bearing part of the stopper member supporting the shaft part is also drawn in that direction and the stopper part abuts and stops on the outer peripheral surface of the stand main body directly or via the press member, whereby the shaft part is fixed so as to be incapable of turning by a drawing force of the support member acting on the shaft part and the resistive force of the stopper member in the opposite direction, and the pressing force of the fastening screw tip end and the stopping force of the stopper part of the stopper member act on the outer peripheral surface of the stand main body directly or via the press member, whereby the support fitting main body is fixed so as to be incapable of turning, and thus both the shaft parts of the connection members and the support fitting main body can be fixed only with operation of the fastening screw to significantly improve operability and fix the shaft parts and the support fitting main body by a strong force.

The support fitting main body is attached to the outer peripheral surface of the stand main body so as to be slidable in an axial direction, and when the fastening screw is fastened to press the outer peripheral surface of the stand main body, the support fitting main body is fixed so as to be incapable of rotating and fixed so as to be incapable of sliding in the axial direction, which makes it possible to fold the legs with the same fastening screw in an efficient manner.

The stand leg includes the support leg that has the lower end placed on the floor surface and the upper end attached to the stand main body, and the connecting stay that has the one end connected to the middle part of the support leg and the other end attached to the stand main body at the position lower than the upper end of the support leg, the support fittings are provided at two places along the axial direction of the stand main body, and of these support fittings, the upper first support fitting is slidable along the axial direction of the stand main body, the support leg is attached to the first support fitting, the connecting stay is attached to the lower second support fitting, and when the first support fitting is slid upward, the stand legs enter into a folded posture along the stand main body, and thus, to adjust the positions of the stand legs, both the first support fitting fastening screw and the second support fitting fastening screw are loosened to turn both of the support fitting main bodies or turn both of the connection members by the same amount from side to side with respect to the support fitting main bodies, and once the positions of the stand legs are decided, the stand legs can be easily fixed by fastening both of the fastening screws. In addition, to fold the leg device, only the same fastening screw of the first support fitting is loosened and the first support fitting is slid upward to fold the stand legs. At that time, the stand legs are fixed at the horizontal positions by the second support fitting, which allows the stand legs to be set at the same positions at the next use time.

The leg device in a musical instrument stand including the two or more stand legs extended from the stand main body to the floor surface and support fittings that attach the stand legs to the stand main body so as to be foldable, and supporting the stand main body together with the pedal device connected to the lower end of the stand main body, wherein the support fittings each include: the two or more concentric support members that are pivotally attached to the outer periphery of the stand main body so as to be capable of turning from side to side around the axis of the stand main body and have at the outer peripheral parts thereof bearing parts to which end parts of the stand legs are pivotally attached so as to be capable of turning up and down around the axis orthogonal to the axis of the stand main body; and the fixing means that, by fastening the screw screwed into one support member of the support members or a fixing member other than the support members, presses or draws the support members in the axis direction of the fastening screw so as to abut and stop on the outer peripheral surface of the stand main body, thereby to fix the fixing members so as to be incapable of turning, wherein turning angles of the support members with respect to the stand main body are adjusted to allow adjustments of side-to-side turning positions of the stand legs pivotally attached to the support members around the axis of the stand main body, and thus it is possible to independently adjust the side-to-side turning positions of the stand legs around the axis of the stand main body, and to adjust the positions of the stand legs in a more optimum manner at setting. Therefore, it is possible to avoid the stand legs from being an impediment and avoid the stand main body from being unstable even when two stand legs are provided. In addition, the support members can be fixed only with operations of the fastening screw to significantly improve operability.

As the fixing member, the member having the annular exterior part to be externally attached to the stand main body is provided, and by fastening the fastening screw, the fixing member is drawn or pressed in the direction opposite to the support member along the axial direction of the fastening screw so as to abut and stop on the outer peripheral surface of the stand main body, thereby to fix the fixing member so as to be incapable of turning, and thus it is possible to fix the support members stably and firmly on the outer peripheral surface of the stand main body via the fastening screws by the fixing members externally attached to the stand main body, and achieve sufficient support strength of the stand legs after the adjustments. In addition, since the fastening screws are provided at the fixing members, not the support members, it is possible to avoid the fastening screws from turning together with the support members to improve operability on adjustments.

The fixing member includes the exterior part and the female screw part to which the fastening screw is screwed, the two or more support members are concentrically arranged adjacent to the exterior part of the fixing member, and by fastening the fastening screw screwed into the female screw part, the fastening screw presses the outer peripheral surfaces of the support members directly or via another member, whereby the support members are pressed on the outer peripheral surface of the stand main body and fixed so as to be incapable of turning, the fixing member moves in the direction toward the base end of the fastening screw with the operation part, and the exterior part is drawn in that direction and abuts and stops on the outer peripheral surface of the stand main body directly or via another member, whereby the fixing member is fixed so as to be incapable of turning with respect to the stand main body, and thus it is possible to fix the support members stably and firmly via the fastening screw by the fixing member, with an increase in support strength of the stand legs.

The female screw part is provided in a penetrating state, and by fastening the fastening screw screwed into the female screw part, the screw tip end part of the fastening screw protruding from the female screw part toward the stand main body presses the outer peripheral surfaces of the support members directly or via another member, whereby the support members are pressed on the peripheral surface of the stand main body and fixed so as to be incapable of turning, and the fixing member moves in the direction toward the base end of the fastening screw, and the exterior part is drawn in that direction and abuts and stops on the outer peripheral surface of the stand main body directly or via another member, and thus it is possible to realize a simple structure even with the fixing member that is small in parts count, low-cost, and lightweight.

The fixing member is almost three-side square-shaped in a vertical cross-sectional view and has the pair of upper and lower annular exterior parts externally attached to the stand main body and the connection part at which the exterior parts are connected and integrated with the space opened in the axial direction on the outside of the stand main body, the connection part being provided with the female screw part, the two or more support members are concentrically arranged in the space between the exterior parts of the fixing member, and by fastening the fastening screw screwed into the female screw part, the screw tip end part of the fastening screw protruding from the female screw part toward the stand main body presses the outer peripheral surfaces of the support members directly or via another member, whereby the support members are pressed against the outer peripheral surfaces of the stand main body and fixed so as to be incapable of turning, and the fixing member moves in the direction toward the base end of the fastening screw, and the exterior parts are drawn in that direction and abut and stop on the outer peripheral surface of the stand main body directly or via another member, and thus the support members supporting the stand legs are arranged in a stable posture between the exterior parts of the fixing member, which makes it possible to fix the support members stably and firmly with an increase in support strength of the stand legs.

The exterior parts of the fixing member are provided so as to be slidable in the axial direction with respect to the stand main body, and by fastening the fastening screw, the fixing member is drawn or pressed in the opposite direction of the support members along the axial direction of the fastening screw and abuts and stops on the outer peripheral surface of the stand main body, whereby the fixing member is fixed so as to be incapable of turning and incapable of sliding in the axial direction, and thus it is possible to fold the legs efficiently using the same fastening screw.

The stand leg includes the support leg that has the lower end placed on the floor surface and the upper end attached to the stand main body and the connecting stay that has the one end connected to the middle part of the support leg and the other end attached to the stand main body at a position lower than the upper end of the support leg, the support fittings are provided at two places along the axial direction of the stand main body, and of the support fittings, the upper first support fitting is slidable in the axial direction of the stand main body, the support leg is attached to the first support fitting, the connecting stay is attached to the lower second support fitting, and when the first support fitting is slid upward, the stand leg enters into a folded posture along the stand main body, and thus, to adjust the positions of the stand legs, both the first support fitting fastening screw and the second support fitting fastening screw are loosened to turn both of the support fittings by the same amount from side to side, and once the positions of the stand legs are decided, the stand legs can be easily fixed by fastening both of the fastening screws. In addition, to fold the leg device, only the same fastening screw of the first support fitting is loosened and the first support fitting is slid upward to fold the stand legs. At that time, the stand legs are fixed at the horizontal positions by the second support fitting, which allows the stand legs to be set at the same positions at the next use time.

### BRIEF DESCRIPTION OF DRAWINGS

FIG. 1 is an entire configuration diagram of a high-hat stand having a leg device according to a first embodiment of the present invention;

FIG. 2 is a perspective view of main components of the leg device in the high-hat stand;

FIG. 3 is an exploded perspective view of the main components of the leg device;

FIG. 4 is a vertical cross-sectional view of the main components of the leg device;

FIG. 5 is another vertical cross-sectional view of the main components of the leg device;

FIG. 6 is a transverse cross-sectional view of stand legs of the leg device under adjustment;

FIG. 7 is another transverse cross-sectional view of the stand legs of the leg device under adjustment;

FIG. 8 is a perspective view of the main components of the leg device in the high-hat stand;

FIG. 9 is an exploded perspective view of the main components of the leg device;

FIG. 10 is a vertical cross-sectional view of the main components of the leg device;

FIG. 11 is a transverse cross-sectional view of the stand legs of the leg device under adjustment;

FIG. 12 is a transverse cross-sectional view of the stand legs of the leg device under adjustment;

FIG. 13(a) is a schematic view of operations of forces in the leg device, and FIG. 13(b) is a schematic view of a modification example;

FIG. 14(a) is a schematic view of another modification example, FIG. 14(b) is a schematic view of still another modification example, FIG. 14(c) is a schematic view of still another modification example, and FIG. 14(d) is a schematic view of still another modification example;

FIG. 15(a) is a schematic view of still another modification example, and FIG. 15(b) is a schematic view of still another modification example;

FIG. 16 is a schematic view of still another modification example;

FIG. 17(a) is an illustrative diagram showing main components of a pedal device in the high-hat stand, and FIG. 17(b) is an illustrative diagram showing the main components of the pedal device under folding;

FIG. 18 is an overall view of the high-hat stand in which the leg device and the pedal device are folded;

FIG. 19 is an entire configuration diagram of a high-hat stand having a leg device according to a second embodiment of the present invention;

FIG. 20 is a perspective view of main components of the leg device in the high-hat stand;

FIG. 21 is an exploded perspective view of the main components of the leg device;

FIG. 22 is another vertical cross-sectional view of the main components of the leg device;

FIG. 23 is a transverse cross-sectional view of stand legs of the leg device under adjustment;

FIG. 24 is a perspective view of the main components of the leg device in the high-hat stand;

FIG. 25 is an exploded perspective view of the main components of the leg device;

FIG. 26 is a vertical cross-sectional view of the main components of the leg device;

FIG. 27 is a transverse cross-sectional view of the stand legs of the leg device under adjustment;

FIG. 28 is a vertical cross-sectional view of main components of a modification example;

FIG. 29 is a vertical cross-sectional view of main components of another modification example;

FIG. 30 is a vertical cross-sectional view of main components of still another modification example;

FIG. 31 is an exploded perspective view of still another modification example;

FIG. 32(a) is a plan view of main components of still another modification example of a leg device, and FIG. 32(b) is a vertical cross-sectional view of main components of the modification example;

FIG. 33(a) is a plan view of main components of still another modification example of a leg device, and FIG. 33(b) is a vertical cross-sectional view of main components of the modification example;

FIG. 34 is a vertical cross-sectional view of main components of still another modification example of a leg device;

FIG. 35 is a vertical cross-sectional view of main components of still another modification example of a leg device; and

FIG. 36 is an overall view of the high-hat stand in which the leg device and the pedal device are folded.

### DESCRIPTION OF EMBODIMENTS

Next, a first embodiment of the present invention will be described in detail with reference to the attached drawings. In the first embodiment described below, a leg device according to the present invention is applied to a high-hat stand. However, the present invention is not limited to this but can be applied to all musical instrument stands.

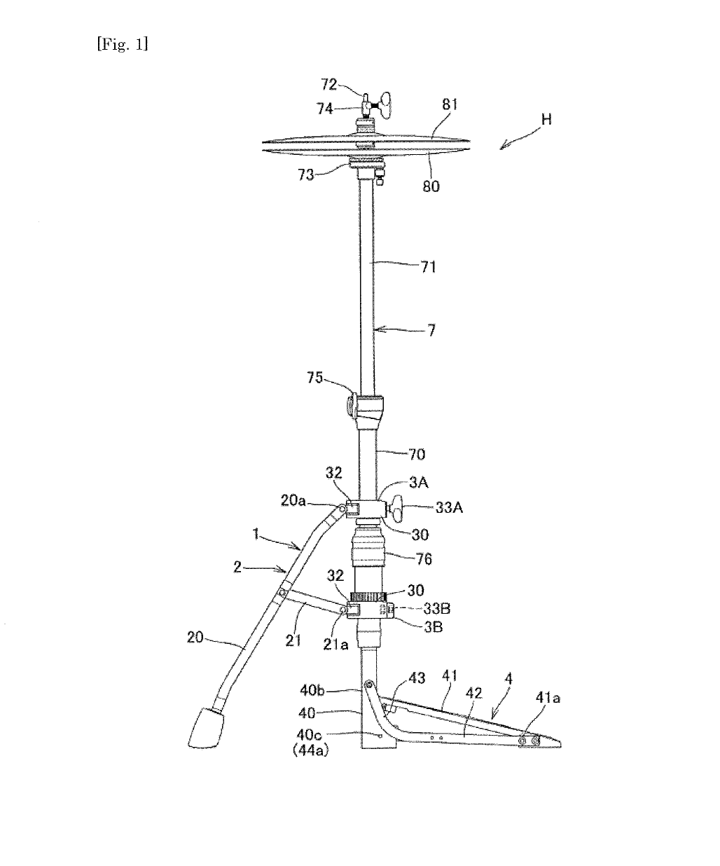

As shown in FIG. 1, a high-hat stand H in the first embodiment includes a stand main body 7 that supports cymbals 80 and 81 as a musical instrument at the upper part thereof, a pedal device 4 for playing the cymbals, and a foldable leg device 1 that supports the stand main body 7. In this example, the high-hat stand H is mainly made from metal materials, but is not particularly limited to this.

The stand main body 7 includes: a lower pipe 70; an upper pipe 71 that is inserted into the upper part of the lower pipe 70 and supported by a thumbscrew 75 so as to be adjustable in height; an up/down rod 72 that is inserted into the lower pipe 70 and the upper pipe 71, raised or lowered by stepping on a pedal 41 protruded downward and connected, and has an upwardly protruding portion at which the upper cymbal 81 is held; a coil spring not shown that is internally attached to the lower pipe 70 to bias upward the up/down rod 72 and separate the upper cymbal 81 from the lower cymbal 80; and a spring tension adjustment device 76 that adjusts a coil spring tension.

The lower cymbal 80 is supported by a cymbal receiver 73 provided at the upper end part of the upper pipe 71, and the upper cymbal 81 is held by a cymbal holder 74 fixed to the upper end part of the up/down rod 72 protruding from the upper end of the upper pipe 71. When the pedal 41 is stepped on, the up/down rod 72 is lowered against the coil spring, and the upper cymbal 81 also descends together with the up/down rod 72 to strike the lower cymbal 80 supported by the cymbal receiver 73.

The leg device 1 includes two stand legs 2 and 2 extended from the stand main body 7 to the floor surface and support fittings 3A and 3B that attach foldably the stand legs 2 and 2 to the stand main body 7. The leg device 1 supports the stand main body 7 together with the pedal device 4 connected to the lower end of the stand main body 7. Each of the stand legs 2 includes a support leg 20 that has a lower end placed on the floor surface and has an upper end part 20a attached to the lower pipe 70 of the stand main body 7 via the support fitting 3A, and a connecting stay 21 that has one end connected to a middle part of the support leg 20 and has the other end part 21a attached to the lower pipe 70 via the support fitting 3B at a position lower than the upper end of the support leg 20.

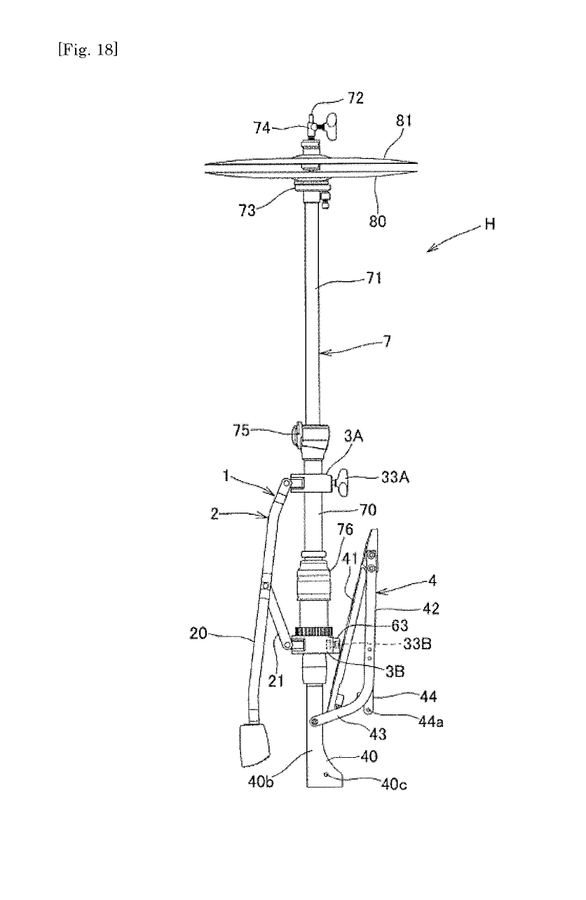

The first support fitting 3A is attached to the stand main body 7 so as to be slidable along an axis direction of the lower pipe 70. The upper end part 20a of the support leg 20 is pivotally supported by the support fitting 3A so as to be capable of turning up and down. The other end part 21a of the connecting stay 21 is pivotally supported by the lower second support fitting 3B so as to be capable of turning up and down. When the first support fitting 3A is slid upward, the stand legs 2 are changed in posture to be folded along the lower pipe 70 as shown in FIG. 18. The stand legs may be structured in another form so as to be foldable by one or two or more support fittings. The stand leg 1 of this example has the two stand legs 2 but may have three or more stand legs as described later.

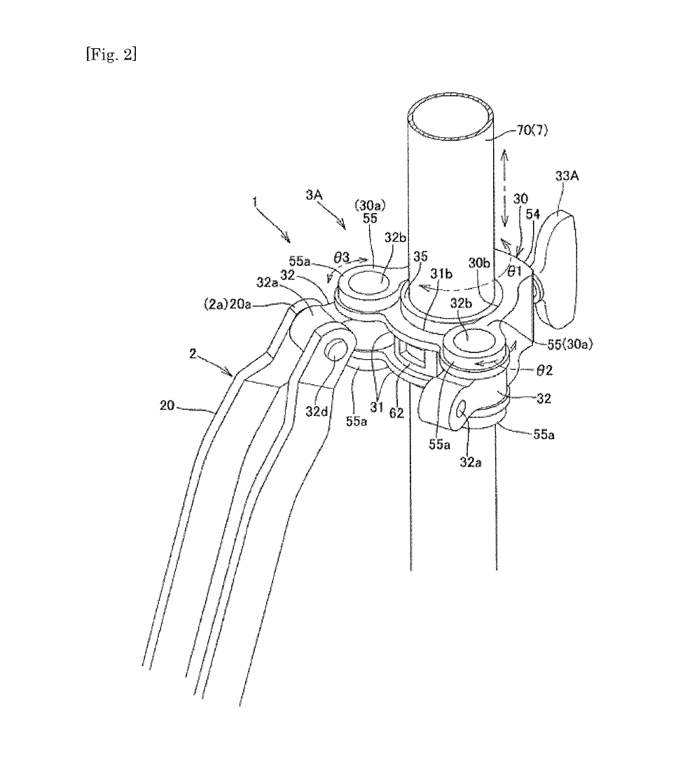

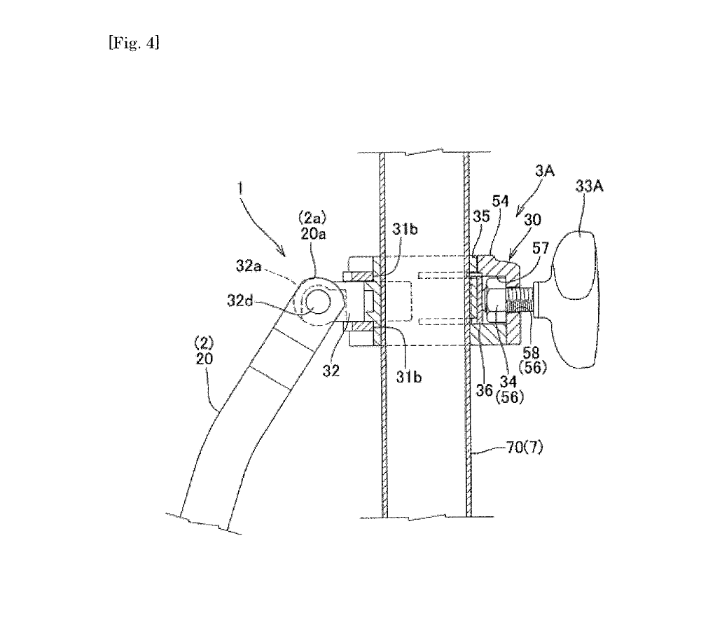

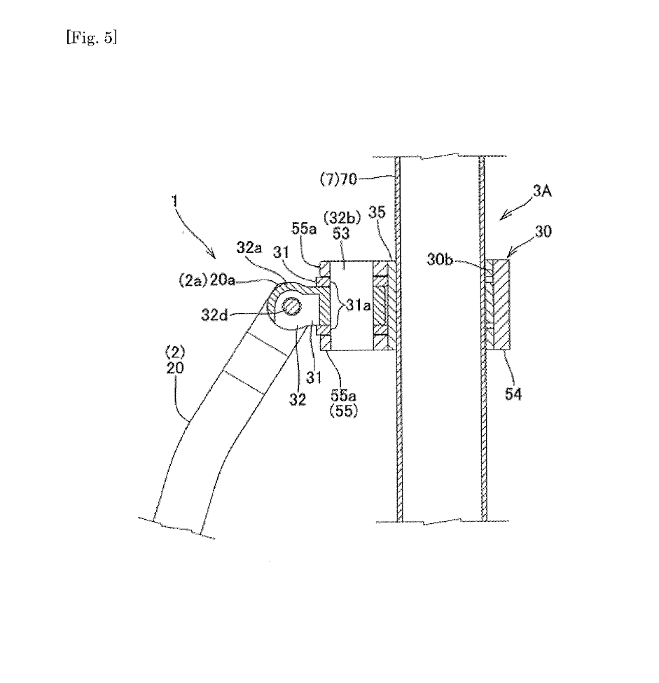

As shown in FIGS. 2 to 7, the first support fitting 3A includes: a support fitting main body 30 that is attached to the outer peripheral surface of the lower pipe 70 of the stand main body 7 so as to be capable of turning from side to side around the central axis of the lower pipe 70 and slidable in a direction along the axis; and connection members 32 and 32 that each have one end part pivotally attached to an outer peripheral part 30a of the support fitting main body 30 so as to be capable of turning from side to side around an axis parallel to the axis of the lower pipe 70 and have at the other end part a bearing part 32a to which the end part 2a of the stand leg 2 is pivotally attached so as to be capable of turning up and down around a shaft 32d orthogonal to the axis of the lower pipe 70.

As shown in FIG. 2, by adjusting angle θ1 at which to turn the support fitting main body 30 from side to side with respect to the lower pipe 70 and angles θ2 and θ3 at which to turn the connection members 32 from side to side with respect to the support fitting main body 30, it is possible to adjust side-to-side turning positions of the stand legs 2 around the axis of the lower pipe 70 and side-to-side turning angles of the stand legs 2 around the axes of the outer peripheral parts 30a of the support fitting main body 30.

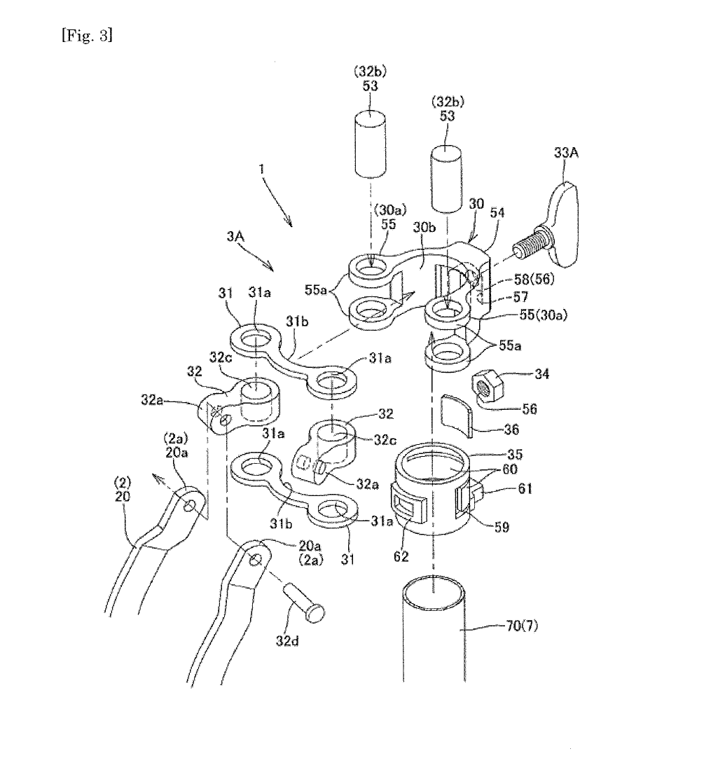

More specifically, as shown in FIGS. 3 to 5, the support fitting main body 30 includes an almost C-shaped inner peripheral surface 30b approximately parallel to the outer peripheral surface of the lower pipe 70, and includes at the outer peripheral parts 30a: bearing parts 55 and 55 supporting shaft parts 32b extended parallel to the axis of the lower pipe 70 provided at one each end part of the connection members 32 so as to be capable of turning from side to side; a support member 54 with a screw hole 56 penetrating the inner peripheral surface toward the axial center of the lower pipe 70; a fastening screw 33A that is screwed into the screw hole 56 and has a penetrating screw tip pressing the outer peripheral surface of the lower pipe 70 of the stand main body 7 via a curved backing plate 36 and a press member 35; and stopper members 31 that have bearing parts 31a and 31a and stopper parts 31b each formed by an inner peripheral surface approximately parallel to the outer peripheral surface of the lower pipe 70 at an opposite position of the fastening screw 33A at least with respect to the lower pipe 70.

The bearing parts 31a of the stopper members 31 are opposed to the bearing parts 55 of the support member 54, and configured to receive and support the shaft parts 32b of the connection members 32 together with the bearing parts 55 so as to be capable of turning from side to side. In this example, the two stopper members 31 are vertically arranged to sandwich the connection members 32 from above and under. Alternatively, the number of the stopper member 31 may be one.

The shaft parts 32b of the connection members 32 are formed by pressing pins 53 into penetration holes 32c formed at one each end part of the connection members 32 and setting vertically protruding portions of the pins 53 as shaft parts. As shown in FIG. 3, when the backing plate 36, the press member 35, and the stopper members 31 are assembled into the support member 54, the pins 53 are inserted into the bearing parts 55 and 31a of the support member 54 and the stopper members 31 and pressed into the penetration holes 32c, whereby the connection members 32 are assembled so as to be capable of turning from side to side.

In this arrangement, the pins 53 may not be pressed but screwed or the like. In addition, if possible, the axial parts 32b may be integrated in the support member 54. The bearing parts 55 of the outer peripheral parts 30a supporting the shaft parts 32b are formed by providing at both end parts of the almost C-shaped support member 54 a pair of vertical annular support parts 55a and 55a for pivotally supporting the shaft parts 32b. The one each end side of the connection members 32 and the bearing parts 31a and 31a of the pair of vertical stopper members 31 and 31 intervene between the vertical annular support parts 55a and 55a.

In this example, the screw hole 56 formed in the support member 54 includes a female screw of a nut 34 attached to a groove part 57 opened at the inner peripheral side of the support member 54 so as to be incapable of rotating and a through hole 58 communicating with the female screw and opened on the outer peripheral surface of the support member 54. The fastening screw 33A is inserted from the through hole 58 and screwed into the female screw of the nut. The screw hole 56 may not be provided with the female screw of the nut 34 but may be directly formed in the support member 54. The fastening screw 33A is a thumbscrew that is structured so as to be easy to operate on adjustment of angles of the legs and folding of the legs.

The press member 35 is a cylindrical synthetic resin molded body with an inner peripheral surface to be directly and closely attached to the outer peripheral surface of the lower pipe 70. The press member 35 is attached to the inside of the annular support fitting main body 30 by the support member 54 and the stopper members 31. The press member 35 has on a side abutting the fastening screw 33A a three-side square-shaped slit groove 59 including two penetrating slit grooves extended approximately halfway in the circumferential direction and a slit groove extended in the axial direction and connecting one each end of the two circumferential slit grooves. The press member 35 has a close-attachment piece 60 that is surrounded by the slit groove 59 and is pressed and deformed inward by the tip end part of the fastening screw 33A while decreasing in diameter to attach closely to the outer peripheral surface of the lower pipe 70. The pressing force of the fastening screw 33A acts on the entire outer peripheral surface of the lower pipe 70 via the close-attachment piece 60, thereby to lock by friction side-to-side turning and up-down sliding in a smooth and reliable manner.

The press member 35 has an anti-drop support base 61 protruded under the close-attachment piece 60 and inserted into the lower portion of the groove part 57 to support from below the nut 34 attached to the groove part 57. The press member 35 also has on a side abutting the stopper members 31 opposite to the support base 61a spacer protrusion 62 between the vertically arranged two stopper members 31 to prevent the stopper members 31 from moving heavily and shifting in position. The backing plate 36 is configured to prevent that a corner of the like at the tip end part of the fastening screw 33A locally presses and scrapes the press member 35, and realize stable pressing of the press member 35, but the 36 may be omitted. In this example, the fastening screw 33A and the stopper parts 31b of the stopper members 31 press the lower pipe 70 via the press member 35. Alternatively, the press member 35 may be omitted such that the fastening screw 33A and the stopper parts 31b of the stopper members 31 press directly the stand main body 7 (lower pipe 70).

In the thus configured support fitting 3A, when the fastening screw 33A is fastened to press the outer peripheral surface of the lower pipe 70 via the press member 35, the support member 54 moves in a direction toward the fastening screw 33A, the bearing parts 55 of the support member 54 draws the shaft parts 32b of the connection members 32 in that direction. At the same time, the bearing parts 31a of the stopper members 31 supporting the shaft parts 32b are also drawn in that direction, whereby the stopper parts 31b of the stopper members 31 abut and stop on the outer peripheral surface of the lower pipe 70 via the press member 35. Subsequently, resistive forces of the bearing parts 31a act on the shaft parts 32b.

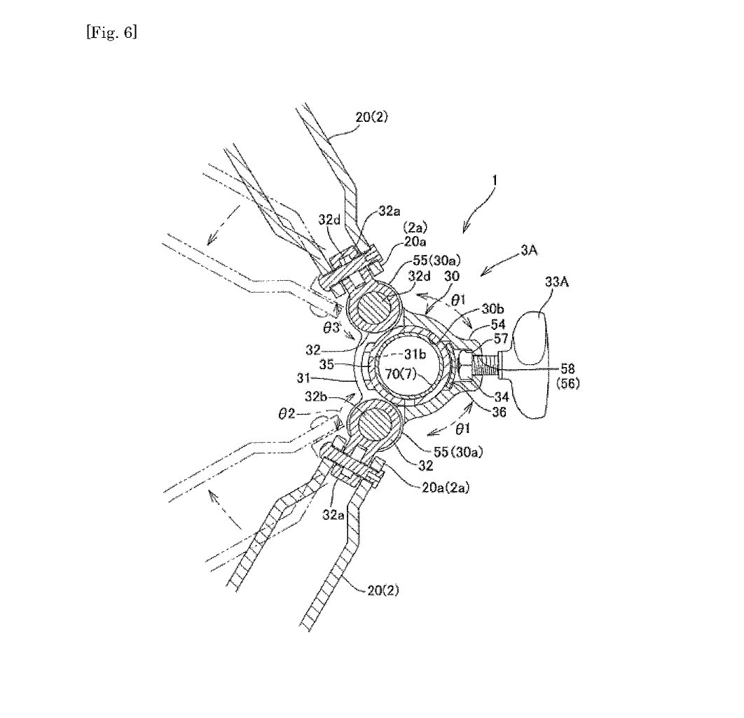

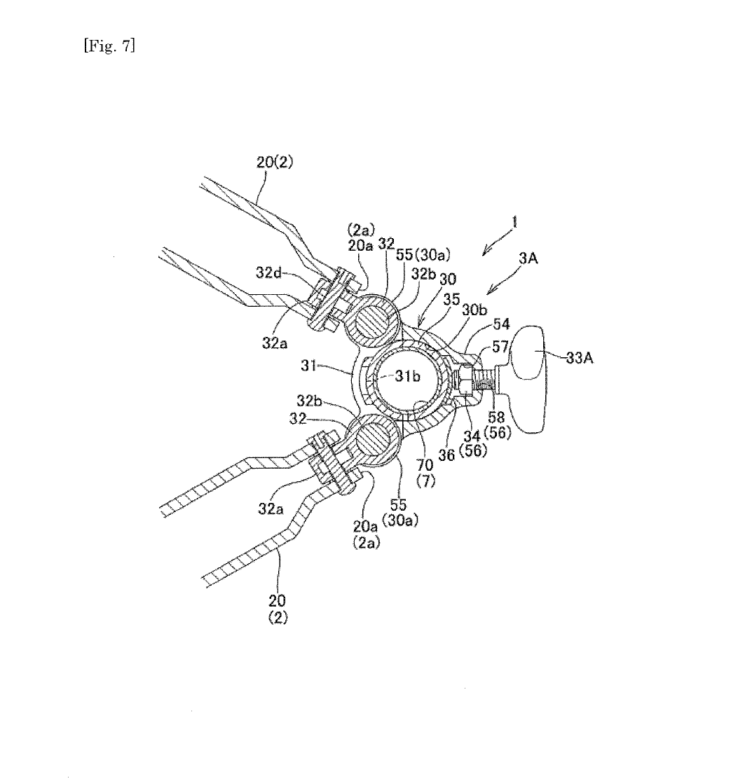

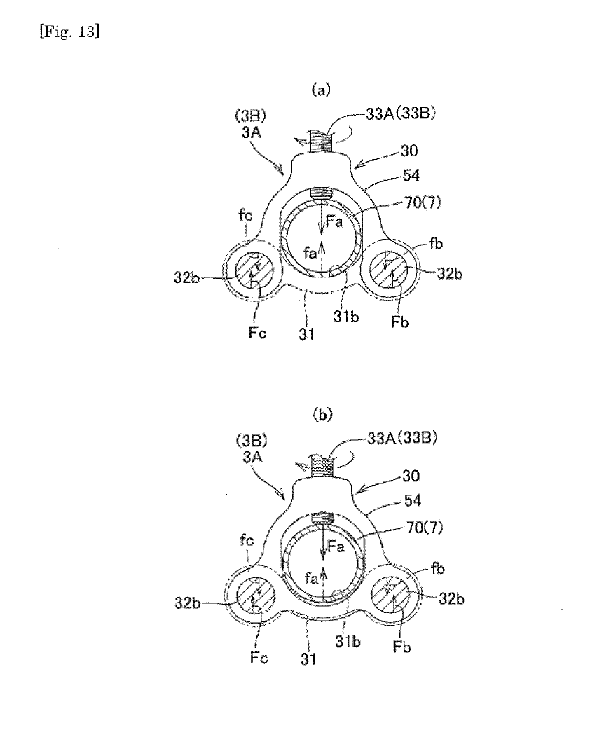

Specifically, when the fastening screw 33A of the support fitting main body 30 is fastened, as shown in FIG. 13(a), drawing forces Fb (Fc) of the support member 54 in the direction toward the fastening screw and resistive forces fb (fc) of the stopper members 31 in the opposite direction act on the shaft parts 32b of the connection members 32, whereby the shaft parts 32b are fixed so as to be incapable of turning. In addition, a pressing force Fa of the tip end of the fastening screw and a stopping force fa of the stopper parts 31b of the stopper members 31 act via the press member on the outer peripheral surface of the lower pipe 70, whereby the support fitting main body 30 is also fixed so as to be incapable of turning or up-down sliding. That is, only by operating the one fastening screw, it is possible to loosen or fix the components so as to be capable of making adjustments to all operations of turning of the connection members 32 with respect to the support fitting main body 30, and turning and up-down sliding of the support fitting main body 30 with respect to the lower pipe 70, as shown in FIGS. 6 and 7.

In this example, the bearing parts 55 (annular supporting parts 55a) and the bearing parts 31a are all shaped in a circular hole form such that each of the holes can independently supports the shaft parts 32b of the connection members so as to be capable of turning. Alternatively, one or both of the bearing parts 55 and 31a may be shaped in a hole form with an inner peripheral wall other than a circular hole form, as far as the bearing parts 55 have the inner peripheral walls supporting the shaft parts 32b so as to be capable of turning at least on a side on which the drawing forces Fb (Fc) act, the bearing parts 31a have the inner peripheral walls supporting the shaft parts 32b so as to be capable of turning at least on a side on which the resistive forces fb (fc) act, and when the bearing parts 55 and 31a are vertically overlapped, an approximately circular hole is formed by the inner peripheral walls of the bearing parts 55 and the inner peripheral walls of the bearing parts 31a.

In this example, the support member 54 has the almost C-shaped inner peripheral surface. Alternatively, the support member 54 may have any other shape, as far as, when the fastening screw 33A is fastened, the stopper parts 31b of the stopper members 31 abut the support member 54 ahead of the inner peripheral surface to generate the resistive forces fb (fc) on the shaft parts 32b. For example, the support member 54 may have an oval annular inner peripheral surface as shown in FIG. 13(b).

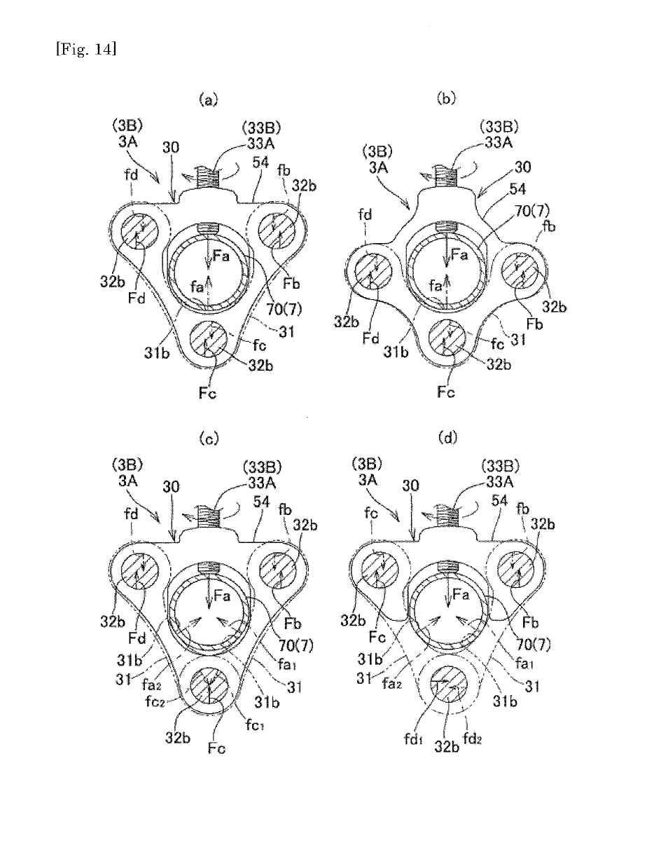

In this example, the two stand legs 2 are provided. Even if three or more stand legs 2 are provided, it is also possible to loosen or fix the components so as to be capable of making adjustments to all operations of turning of the connection members with respect to the support fitting main body, and turning and up-down sliding of the support fitting main body with respect to the lower pipe, only by operating the one fastening screw. FIG. 14(a) shows an example in which three stand legs are arranged at intervals of 120 degrees. In this case, the pedal device may not necessarily have sufficient support strength as a leg. FIG. 14(b) shows an example in which three stand legs are arranged at intervals of 90 degrees to constitute four legs in conjunction with the pedal device.

In either example, the support member 54 has three bearing parts and the stopper members 31 has three bearing parts, such that the drawing forces Fb (Fc, and Fd) of the support member 54 in the direction toward the fastening screw and the resistive forces fb (fc, and fd) of the stopper members 31 in the opposite direction act on the shaft parts 32b of the connection members, thereby to fix the shaft parts 32b so as to be incapable of turning, and the pressing force Fa of the tip end of the fastening screw and the stopping force fa of the stopper parts 31b of the stopper members 31 act on the outer peripheral surface of the lower pipe 70, thereby to fix the support fitting main body 30 so as to be incapable of turning or up-down sliding at the same time.

Further, in the case where three or more stand legs are provided, instead of providing one stopper member 31 with three bearing parts supporting the shaft parts 32b of the connection members, the stopper members 31 and 31 may be provided with two bearing parts between the adjacent shaft parts 32b and 32b excluding a portion corresponding to the fastening screw as shown in FIG. 14(c).

In the structure of FIG. 14(c), when the fastening screw is fastened, the drawing forces Fb (Fc, and Fd) of the support member 54 in the direction toward the fastening screw and the resistive forces fb (fc1, fc2, and fd) of the stopper members 31 in the opposite direction act on the shaft parts 32b, thereby to fix the shaft parts 32b so as to be incapable of turning. In addition, the pressing force Fa of the tip end of the fastening screw and the stopping forces fa1 (fa2) of the stopper parts 31b of the stopper members 31 act via the pressing member on the outer peripheral surface of the lower pipe 70, thereby to fix the support fitting main body 30 so as to be incapable of turning or up-down sliding at the same time.

Further, in the case where three or more stand legs are provided, instead of providing the support member 54 with three bearing parts supporting the shaft parts 32b of the connection members, it is possible to set the support member 54 as a member with an approximately C-shaped inner peripheral surface, provide the support member 54 with at least bearing parts supporting the two shaft parts 32b and 32b sandwiching a portion corresponding to the fastening screw, and omit other components such that the shaft parts 32b are supported only by the bearing parts of the stopper members 31 as shown in FIG. 14(d).

In the structure of FIG. 14(d), when the fastening screw is fastened, the shaft parts 32b supported only by the bearing parts of the stopper members 31 are submitted to the drawing forces fd1 and fd2 of the stopper members 31 and 31, and are fixed so as to be incapable of turning. In addition, at the stopper members 31 connected to each other by the shaft parts 32b, the stopping forces fa1 (fa2) of the stopper parts 31b act on the outer peripheral surface of the lower pipe, thereby to fix the support fitting main body 30 so as to be incapable of turning or up-down sliding at the same time. In this example, as in the case of FIG. 14(c), the two stopper members with the two bearing parts are connected together, but only one stopper member with three bearing parts may be used.

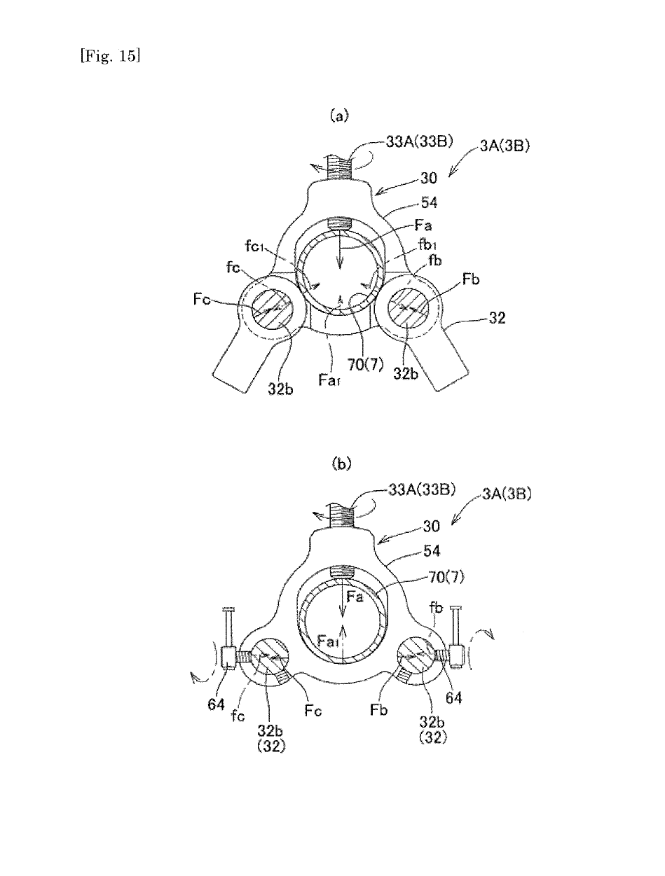

In another modification example, as shown in FIG. 15(a), for instance, the stopper members 31 are omitted such that the shaft parts 32b are fixed so as to be incapable of turning by the drawing force Fb of the support member 54 in the direction toward the fastening screw and the resistive force of the connection members 32 abutting and stopping on the press member or the outer peripheral surface of the lower pipe. In addition, as shown in FIG. 15(b), the shaft parts 32b may be pressed and fixed directly by screws 64. Further, in this example, the shaft parts 32b are provided at the one each end part of the connection members 32 and the bearing parts are pivotally supported at the support fitting main body 30 side, but the shaft parts may be provided at the support member side and the bearing parts may be provided at the one each end part of the connection members.

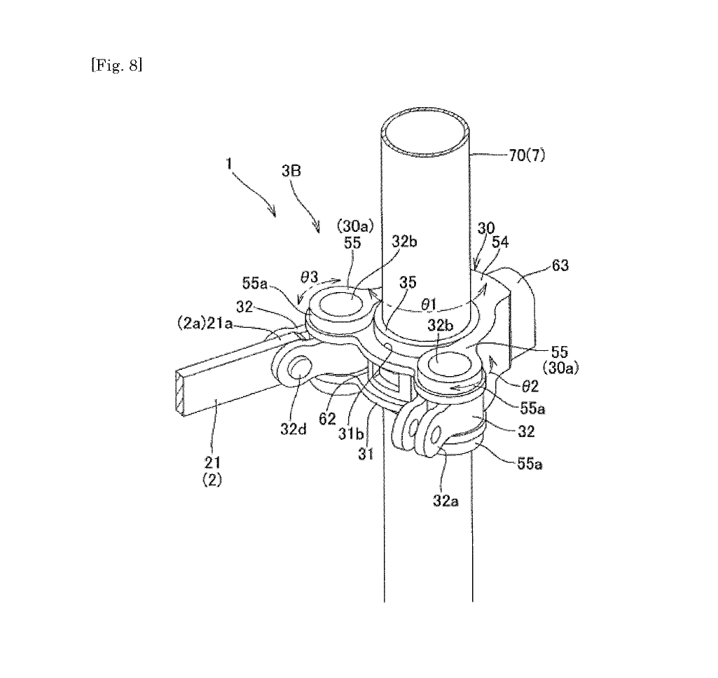

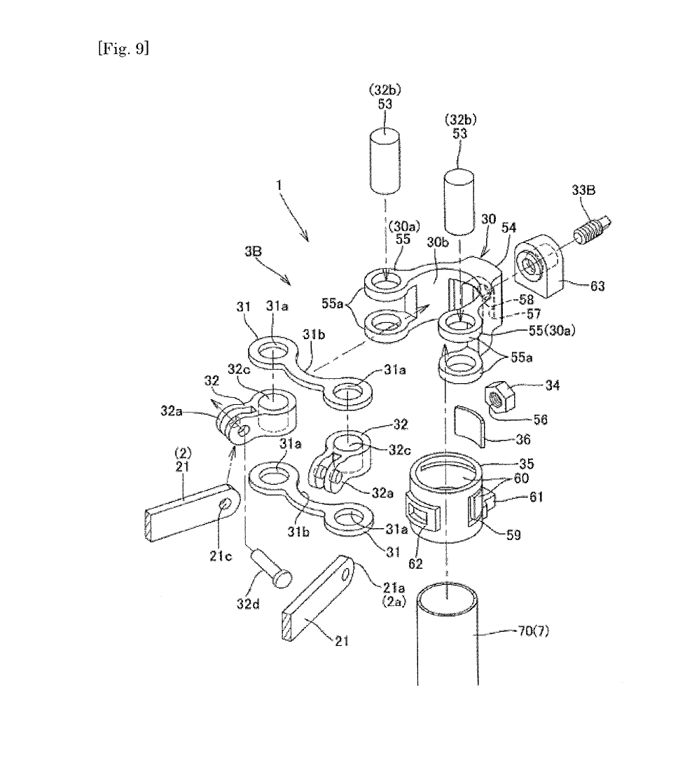

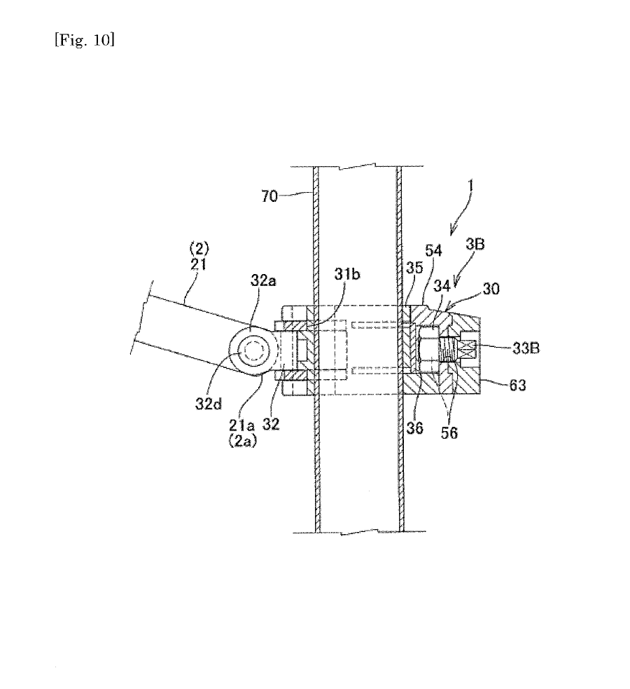

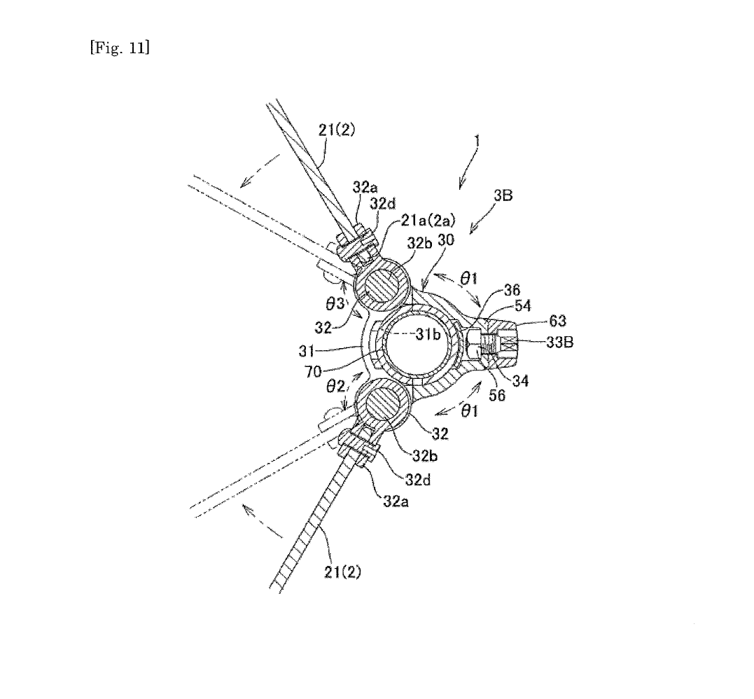

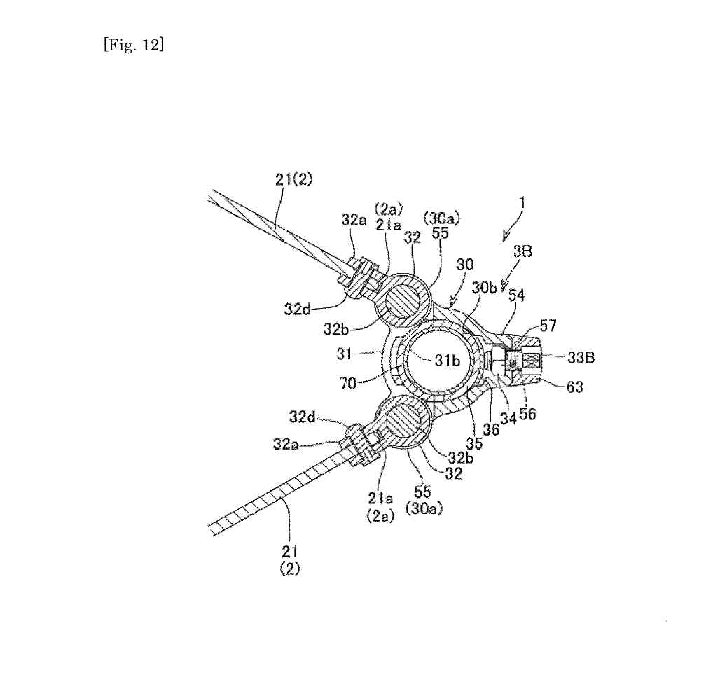

As shown in FIGS. 8 to 12, the second support fitting 3B includes: a support fitting main body 30 that is attached to the outer peripheral surface of the lower pipe 70 of the stand main body 7 so as to be capable of turning from side to side around the central axis of the lower pipe 70; and connection members 32 and 32 that include bearing parts 32a each having one end part pivotally attached to outer peripheral parts 30a of the support fitting main body 30 so as to be capable of turning from side to side around an axis parallel to the axis of the lower pipe 70, and each having the other end part to which the end parts 2a of the stand legs 2 are pivotally attached so as to be capable of turning in the up-down direction around an axis orthogonal to the axis of the lower pipe 70.

In the case of the first support fitting 3A, as shown in FIGS. 8, 11, and 12, by adjusting angle θ1 at which to turn the support fitting main body 30 from side to side with respect to the lower pipe 70 and angles θ2 and θ3 at which to turn the connection members 32 from side to side with respect to the support fitting main body 30, it is possible to adjust both side-to-side turning positions of the stand legs 2 around the axis of the lower pipe 70 and side-to-side turning angles of the support fitting main body 30 around the axes of the outer peripheral parts 30a. However, unlike the first support fitting 3A, the support fitting main body 30 is incapable of sliding in the direction along the axis of the lower pipe 70, that is, is fixed at the vertical position.

A fastening screw 33B is not a thumbscrew but a bolt operated by a dedicated tool, and has therearound a protective cover 63 made of rubber or synthetic resin elastomer or the like to protect the bolt such that the folded pedal does not hit the head of the bolt. In the support fitting 3B, as shown in FIG. 13(a), when the fastening screw 33B is fastened, drawing forces Fb (Fc) of a support member 54 in the direction toward the fastening screw and resistive forces fb (fc) of stopper members 31 in the opposite direction act on shaft parts 32b of the connection members 32, thereby to fix the shaft parts 32b so as to be incapable of turning. In addition, pressing force Fa of the tip end of the fastening screw and stopping force fa of the stopper parts 31b of the stopper members 31 act via the press member on the outer peripheral surface of the lower pipe 70, thereby to fix the support fitting main body 30 so as to be incapable of turning at the same time.

That is, the second support fitting 3B is structured such that, only by operating the one fastening screw 33B, it is possible to loosen or fix the components so as to be capable of making adjustments to all operations of turning of the connection members 32 with respect to the support fitting main body 30, and turning of the support fitting main body 30 with respect to the lower pipe 70. Other configurations and modification examples of the second support fitting 3B are almost the same as those of the first support fitting 3A, and thus the same components are given the same reference numerals and descriptions thereof are omitted.

To adjust the positions of the stand legs 2, both the fastening screw 33A of the first support fitting 3A and the fastening screw 33B of the second support fitting 3B are loosened to turn the both support fitting main bodies 30 from side to side by the same amount with respect to the lower pipe 70 or turn the both connection members 32 from side to side by the same amount with respect to the support fitting main body 30, and once the positions of the two stand legs 2 are decided, the both fastening screw 33A and 33B are fastened to fix the stand legs 2. To fold the leg device 1, only the fastening screw 33A of the first support fitting 3A is loosened and the first support fitting 3A is slid upward to fold the stand legs. At that time, the horizontal positions of the stand legs remain fixed by the second support fitting 3B so that the stand legs can be set at the same positions for the next use.

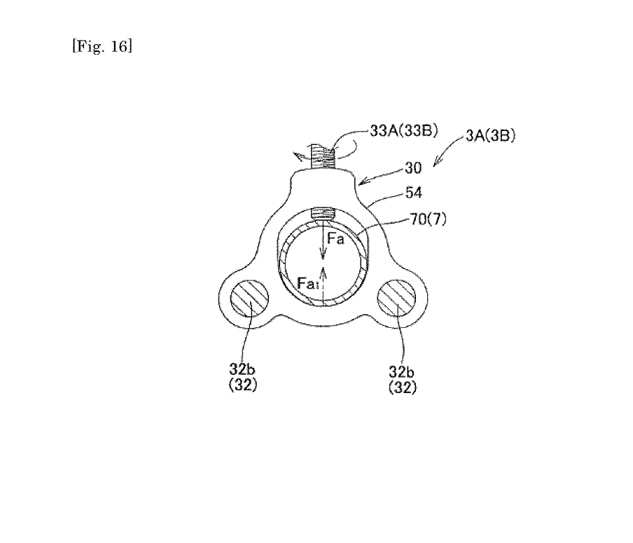

In this example, the support fitting 3A and the 3B are almost the same in structure but may have different structures, that is, one or both may be structured as in the modification examples or in any other manner. In addition, either of the support fittings may fix side-to-side turning of the support fitting main body 30 with respect to the lower pipe 70 but not fix turning of the connection members 32 with respect to the support fitting main body 30 such that the connection members 32 can freely turn at any time, as shown in FIG. 16. By employing a connection support structure with strength enough to firmly hold the stand legs without side-to-side swing, it is possible to maintain the stable posture of the two stand legs in which, even when one of the stand legs is free, the other is fixed with the connection member.

In this example, all the stand legs 2 are capable of turning via the connection members 32 with respect to the support fitting main body 30. Alternatively, one of the stand legs 2 may be fixed so as to be incapable of turning with respect to the support fitting main body 30. In addition, the support fittings 3A and 3B of this example are both attached to the lower pipe 70 constituting the stand main body 7. Alternatively, as a matter of course, one or both may be attached to another member (intermediate pipe or the like) constituting the stand main body.

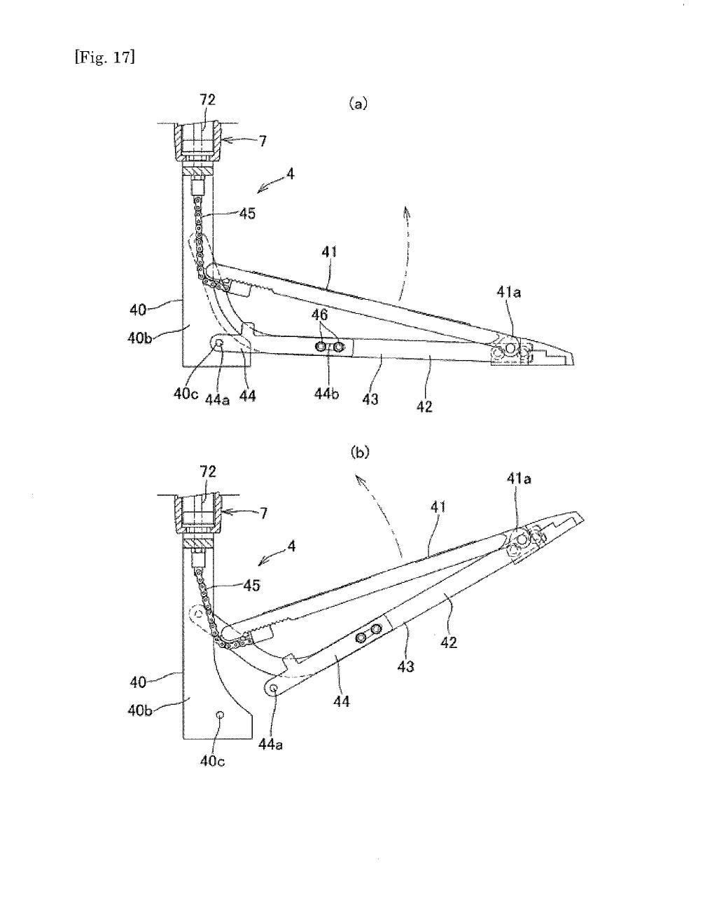

As shown in FIG. 17(a), the pedal device 4 includes: a support frame 40 that has an upper end fixed to the lower end of the stand main body 7 and is placed on the floor surface; a connection frame 42 that is pivotally supported so as to be capable of turning up and down with respect to the support frame 40 and is extended in the horizontal direction along the floor surface; a pedal 41 that has a heel part 41a (back end part) connected to a tip end part of the connection frame 42 so as to be capable of turning up and down; and a transfer member 45 such as a belt connecting a front end part of the pedal 41 to the lower end of the up/down rod 72.

The support frame 40 is square-shaped in a front view with upper and lower frames and right and left support columns, and one pair of the connection frames 42 is pivotally supported at right and left support columns 40b. Each of the connection frames 42 includes: an almost L-shaped main frame 43 that is obliquely extended to the floor surface from an end part of the connection frame pivotally supported at the middle part of the support column 40b, and is bent and extended in the horizontal direction along the floor surface; and a branched piece 44 that is extended horizontally from the bent part of the main frame 43 toward the support frame 40.

Each of the branched pieces 44 has at an end part thereof an engagement protrusion 44a engaging an engagement hole 40c in the vicinity of the lower ends of the support column 40b. When the engagement protrusions 44a and the engagement holes 40c are engaged with each other to connect the branched pieces 44 to the support frame 40, the connection frames 42 are fixed to the support frame 40, whereby the pedal device 4 functions as a leg supporting the stand main body 7. In this example, the branched pieces 44 are attached to the main frames 43 so as to be adjustable in position along the horizontal direction toward the support frame 40. Accordingly, when the branched pieces 44 are adjusted so as to move in the direction toward the support frame 40 with respect to the main frames 43, for example, the parts of the branched pieces 44 extended from the support frame 40 become longer. In this state, when the branched pieces 44 are connected to the support frame 40 as described above, the support frame 40, the stand main body 7, and the cymbals 80 and 81 can be inclined toward the pedal, that is, the player, as compared to before the adjustment. In this example, the branched pieces 44 are provided with elongated holes 44b along the horizontal direction, fixing screws 46 and 46 penetrate through the elongated holes 44b and screw into the main frame 43 to fix the branched pieces 44 to the main frames 43. When the fixing screws 46 and 46 are loosened, the branched pieces 44 with the elongated holes 44b can be moved in the horizontal direction, whereby the fixing positions of the branched pieces 44 can be adjusted by the fixing screws 46 and 46. However, the present invention is not limited to the foregoing configuration. In addition, to fold the pedal device, as shown in FIG. 17(b), the engagement is released to separate the branched pieces 44 from the support columns 40b, and the connection frames 42 can be turned upward with respect to the support frame 40 to change into the folded posture along the lower pipe 70 as shown in FIG. 18.

Next, a second embodiment of the present invention will be described in detail with reference to the attached drawings. In the second embodiment, the leg device according to the present invention is applied to a high-hat stand. However, the present invention is not limited to this but can be applied to all musical instrument stands.

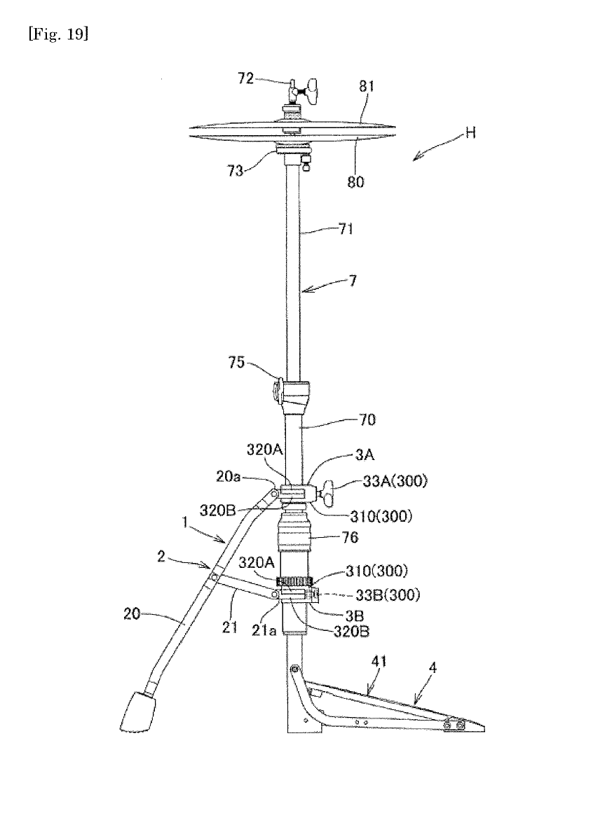

As shown in FIG. 19, the high-hat stand H in the second embodiment includes the stand main body 7 supporting the cymbals 80 and 81 as a musical instrument at the upper part thereof, the pedal device 4 for playing the cymbals, and the foldable leg device 1 that supports the stand main body 7. In this example, the high-hat stand H is mainly made from a metal material, but is not particularly limited to this.

The stand main body 7 includes: the lower pipe 70; the upper pipe 71 that is inserted into the upper part of the lower pipe 70 and supported by the thumbscrew 75 so as to be adjustable in height; the up/down rod 72 that is inserted into the lower pipe 70 and the upper pipe 71, raised or lowered by stepping on the pedal 41 protruded downward and connected, and has the upwardly protruding portion at which the upper cymbal 81 is held; a coil spring not shown that is internally attached to the lower pipe 70 to bias upward the up/down rod 72 and separate the upper cymbal 81 from the lower cymbal 80; and the spring tension adjustment device 76 that adjusts a coil spring tension.

The lower cymbal 80 is supported by the cymbal receiver 73 provided at the upper end part of the upper pipe 71, and the upper cymbal 81 is held by the cymbal holder 74 fixed to the upper end part of the up/down rod 72 protruding from the upper end of the upper pipe 71. When the pedal 41 is stepped on, the up/down rod 72 is lowered against the coil spring, and the upper cymbal 81 also descends together with the up/down rod 72 to strike the lower cymbal 80 supported by the cymbal receiver 73.

The leg device 1 includes the two stand legs 2 and 2 extended from the stand main body 7 to the floor surface and the support fittings 3A and 3B that attach foldably the stand legs 2 and 2 to the stand main body 7. The leg device 1 supports the stand main body 7 together with the pedal device 4 connected to the lower end of the stand main body 7. Each of the stand legs 2 includes the support leg 20 that has the lower end placed on the floor surface and has the upper end part 20a attached to the lower pipe 70 of the stand main body 7 via the support fitting 3A, and the connecting stay 21 that has one end connected to the middle part of the support leg 20 and has the other end part 21a attached to the lower pipe 70 via the support fitting 3B at a position lower than the upper end of the support leg 20.

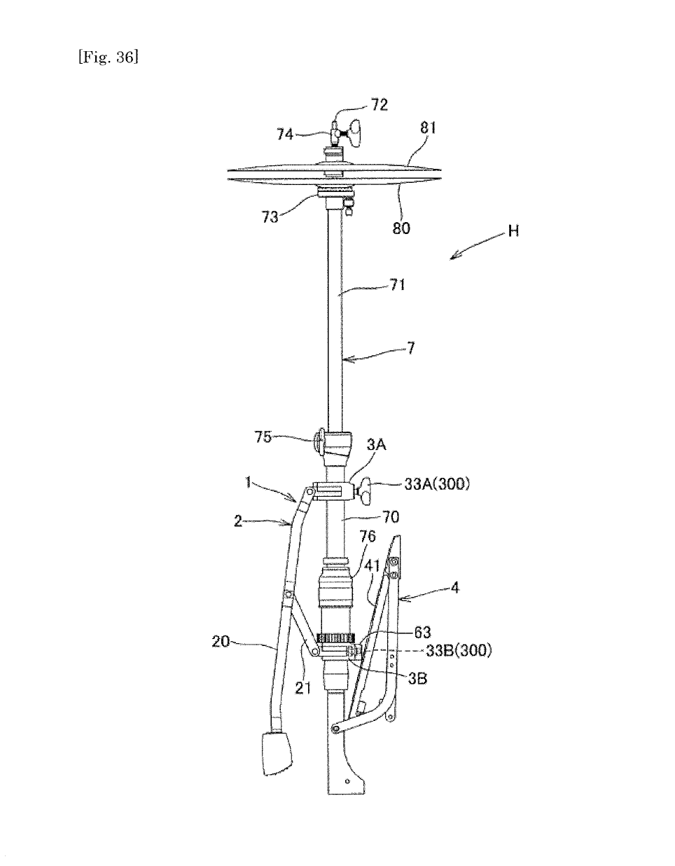

The first support fitting 3A is attached to the stand main body 7 so as to be slidable along the axis direction of the lower pipe 70. The upper end part 20a of the support leg 20 is pivotally supported by the support fitting 3A so as to be capable of turning up and down. In addition, the lower second support fitting 3B is attached to the lower pipe 70 so as to be incapable of sliding in the axial direction, and the other end part 21a of the connecting stay 21 is pivotally supported by the lower second support fitting 3B so as to be capable of turning up and down. When the first support fitting 3A is slid upward, the stand legs 2 are changed in posture to be folded along the lower pipe 70 as shown in FIG. 36. The stand legs may be structured in another form so as to be foldable by one or two or more support fittings. The leg device 1 of this example has the two stand legs 2 but may have three or more stand legs as described later.

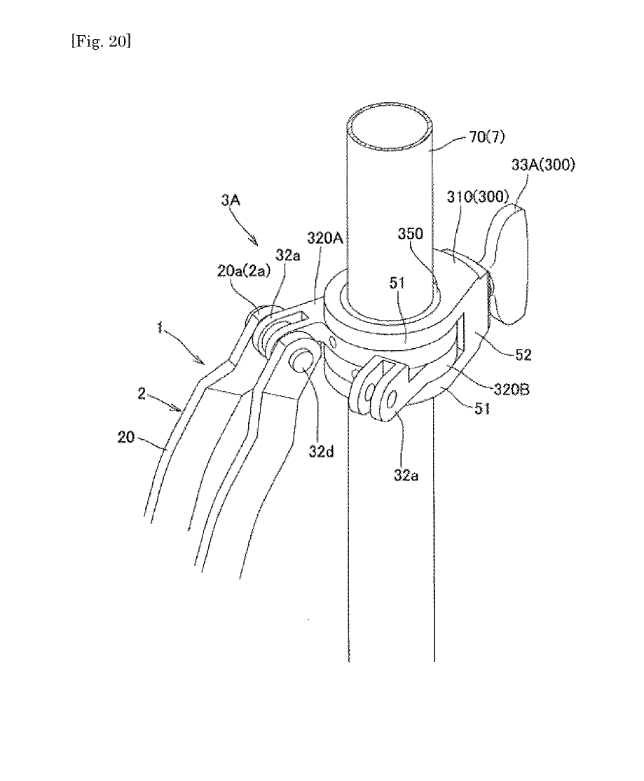

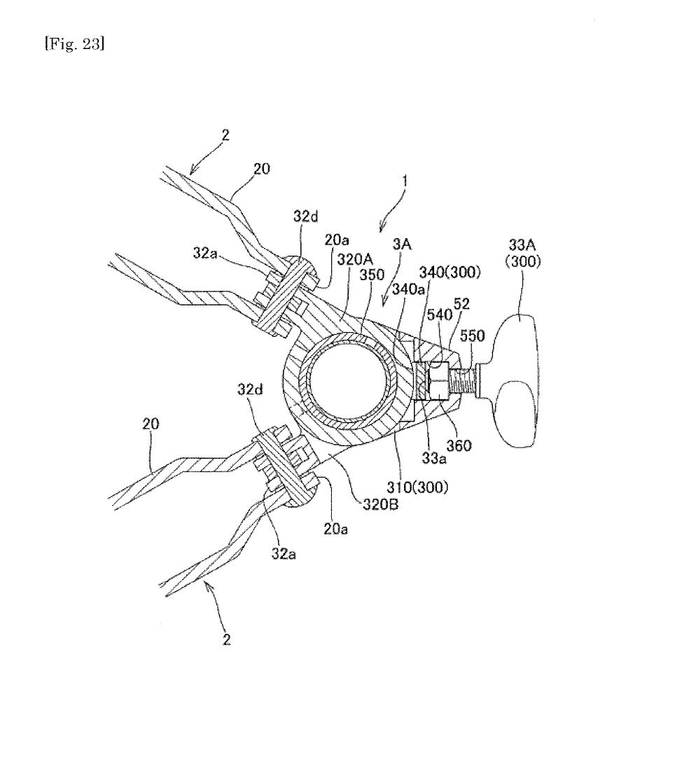

As shown in FIGS. 20 to 23, the first support fitting 3A includes: support members 320A and 320B that are concentric to each other and are attached to the outer periphery of the lower pipe 70 of the stand main body 7 so as to be capable of turning from side to side around the central axis of the lower pipe 70; and a fixing means 300 formed by a fixing member 310 and the fastening screw 33A. When the fastening screw 33A is operated to adjust the turning angles (fixing positions) of the support members 320A and 320B with respect to the lower pipe 70, it is possible to adjust the side-to-side turning positions of the stand legs 2 around the axis of the lower pipe 70.

The support members 320A and 320B have the bearing parts 32a at the outer peripheral parts thereof. The end parts 2a of the stand legs 2 are pivotally attached to the bearing parts 32a so as to be capable of turning up and down around the shaft 32d orthogonal to the axis of the lower pipe 70. The number of the support members 320A and 320B are the same as the number of the stand legs 2, and if three or more stand legs 2 are provided, three or more support members are provided accordingly.

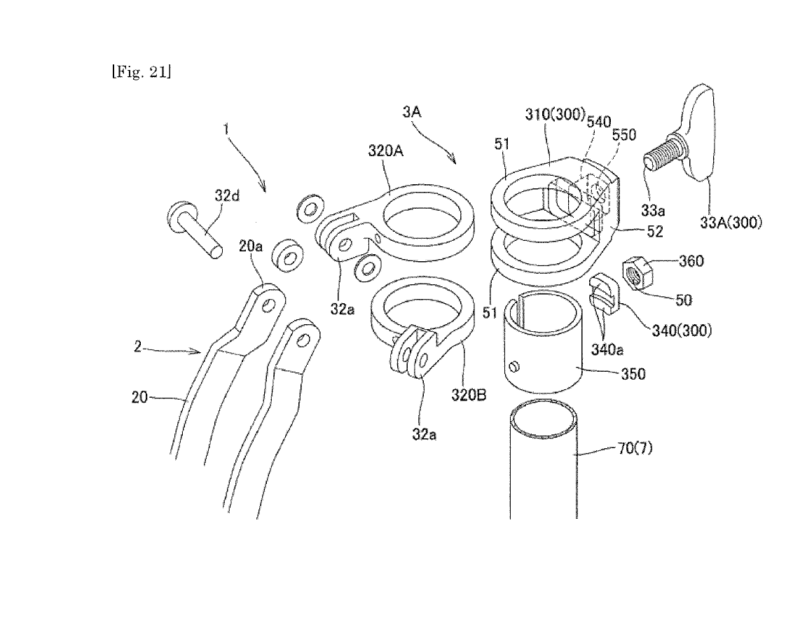

As shown in FIGS. 21 to 23, the fixing member 310 includes annular exterior parts 51 externally attached to the stand main body 7 (lower pipe 70) and a female screw part 50 into which the fastening screw 33A is screwed. More specifically, The fixing member 310 is almost three-side square-shaped in a vertical cross-sectional view, and has the pair of vertical exterior parts 51 and 51 and a connection part 52 that connects together the exterior parts 51 with a space therebetween in the axial direction on the outside of the stand main body 7 (lower pipe 70), and the connection part 52 being provided with the female screw part 50. The support members 320A and 320B are concentrically arranged in the space between the exterior parts 51 and 51.

When the fastening screw 33A is screwed and fastened into the female screw part 50 of the connection part 52, a screw tip end portion 33a of the fastening screw 33A protruding from the female screw part 50 toward the lower pipe 70 presses the outer peripheral surfaces of the support members 320A and 320B. Accordingly, the support members 320A and 320B are pressed against and fixed to the outer peripheral surface of the lower pipe 70 so as to be incapable of turning, and the fixing member 310 is moved in the direction toward the base end of the fastening screw 33A, whereby the exterior parts 51 and 51 are drawn in that direction and stopped on the outer peripheral surface of the lower pipe 70.

The fixing member 310 of the first support fitting 3A needs to be slidable up and down at least along the axial direction of the lower pipe 70 but does not necessarily need to be capable of turning with respect to the stand main body 7. For example, the lower pipe 70 may have on the outer periphery a guide part as a concave or convex streak along the axial direction, such that the fixing member can be engaged with the guide part and attached to the lower pipe 70 so as to be capable of up-down sliding and incapable of turning. By thus configuring the fixing member so as to be incapable of turning, the turning position of the fastening screw 33A can be fixed, thereby to further improve operability.

In this example, the female screw part 50 includes a female screw of a nut 360 attached to a groove part 540 opened on the inner peripheral side of the connection part 52 of the fixing member 310 so as to be incapable of rotating, and a through hole 550 communicating with the female screw and opened on the outer peripheral surface of the female screw part 50. The fastening screw 33A is inserted from the through hole 550 and screwed into the female screw of the nut. Instead of providing the female screw part 50 with the female screw of the nut 360 as described above, a screw hole may be formed directly in the connection part 52. The fastening screw 33A is a thumbscrew structured to be easy to operate for angle adjustment and folding of the legs.

The exterior parts 51 have ring-shaped inner peripheral surfaces approximately parallel to the outer peripheral surface of the lower pipe 70. However, there is no limitation on the shape of the exterior parts 51 as far as the exterior parts 51 have at least stopper portions abutting and stopping on the outer peripheral surface of the lower pipe 70 on the opposite side of the screw attachment part. For example, the exterior parts 51 may not be annular but may be almost C-shaped in a plan view that is partly cut off by a smaller width than the diameter of the lower pipe.

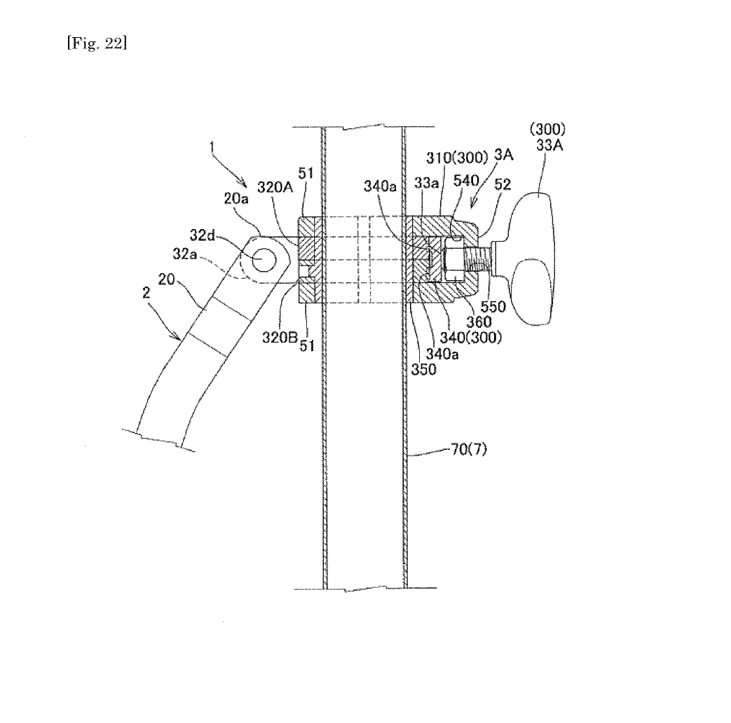

As shown in FIGS. 21 and 22, a press member 340 almost three-side square-shaped in a vertical cross-sectional view with vertically-arranged protrusions 340a for pressing the support members 320A and 320B intervenes in a groove 540 between the fastening screw tip end part 33a and the support members 320A and 320B. As a matter of course, the screw tip end part 33a may be configured to press directly the both outer peripheral surfaces of the support members 320A and 320B. In this case, however, if there is a dimension error in the support members 320A and 320B, there occurs a problem that one support member earlier abutting the screw tip end part 33a is pressed and stopped so as to be incapable of turning, whereas the other support member is not pressed or stopped but remain capable of turning.

Meanwhile, as in this example, since the outer peripheral surfaces of the support members 320A and 320B are pressed via the press member 340, even if there is a dimension error in outer diameters of the support members 320A and 320B, the press member 340 inclines until the protrusions 340a and 340a of the press member 340 abut the outer peripheral surfaces of the support members 320A and 320B to absorb the error, thereby allowing the pressing force of the screw tip end part 33a to act almost uniformly on both of the support members 320A and 320B. Therefore, it is possible to avoid the foregoing problem and allow both of the support members to stop so as to be incapable of turning in a reliable manner. The protrusions 340a and 340a of the press member 340 may be omitted because a similar effect of absorbing the error can be produced without the protrusions.

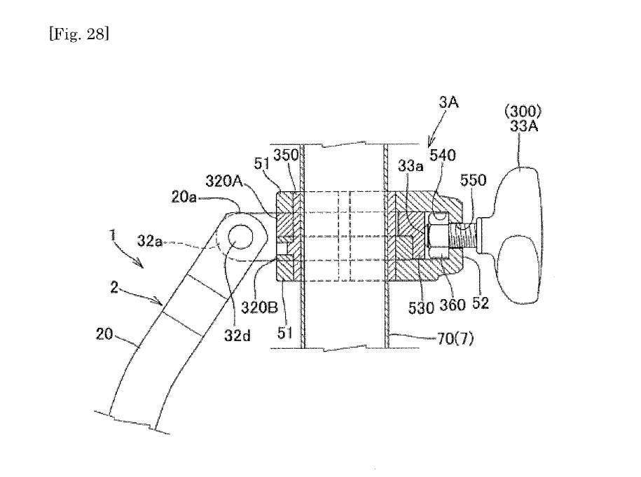

The press member 340 may be omitted as in the configuration shown in FIG. 28. Specifically, it is also preferred that the other support member 320B is pressed by the fastening screw 33A via the one support member 320A, thereby to allow the support member 320B to abut and stop on the outer peripheral surface of the lower pipe 70 and allow the support member 320A to abut and stop on the support member 320B, such that the two support members are fixed so as to be incapable of turning. According to the configuration, it is possible to avoid the foregoing problem resulting from a dimension error. In this configuration, the support members 320A and 320B are provided with a latch part 530 to latch the two each other in the direction of the axial center. The latch part 530 allows the one support member 320A to press the other support member 320B. In this example, as the latch part 530, the one support member 320A is provided with a protruding piece for pressing the outer peripheral surface of the other support member 320B in a direction toward the support member 320A (downward). Alternatively, the support member 320B may be provided with a concave groove on an upper surface of a radially middle part thereof, and the support member 320A may be provided with a convex part engaging the concave groove.

The support members 320A and 320B and the exterior parts 51 and 51 of the fixing member 310 are not directly attached to the outer peripheral surface of the lower pipe 70 but are externally attached to the lower pipe 70 via a synthetic resin spacer member 350. Alternatively, the spacer member 350 may be omitted such that the foregoing components are directly attached to the outer peripheral surface of the stand main body 7 (lower pipe 70).

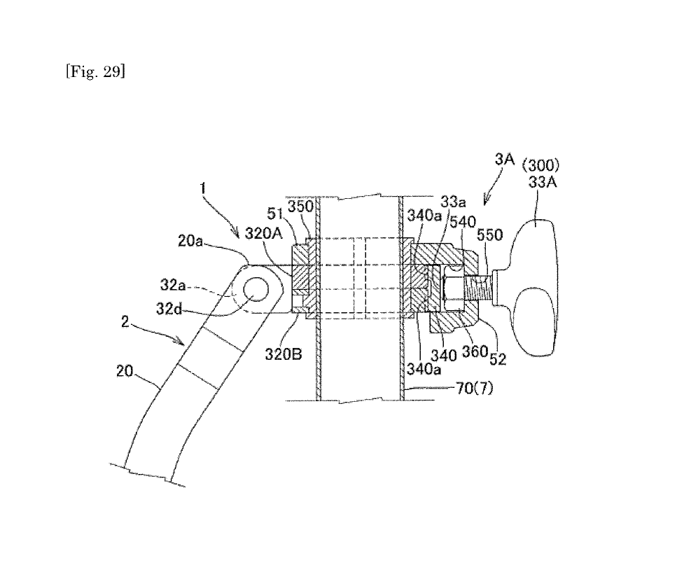

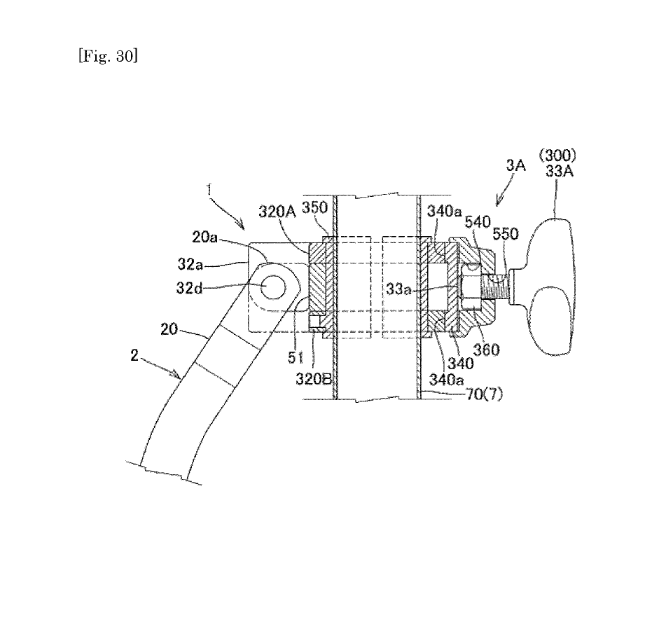

The support members 320A and 320B are concentric to each other and arranged adjacent to the pair of upper and lower exterior parts 51 and 51 so as to be sandwiched between the upper and lower exterior parts 51 and 51. Therefore, it is possible to attach the support members 320A and 320B between the exterior parts 51 and 51 of the fixing member 310 in a stable posture without shaking in the axial direction so as to be capable of turning, and it is possible to support reliably counteracting forces of stand loads received from the stand legs 2. However, the present invention is not limited to this structure. For example, as shown in FIG. 29, only one exterior part 51 may be provided such that a plurality of support members is concentrically aligned on one of the upper and lower sides adjacent to the exterior part 51, or as shown in FIGS. 30 to 32, support members are concentrically arranged adjacent to each other on both the upper and lower sides of the one exterior part 51.

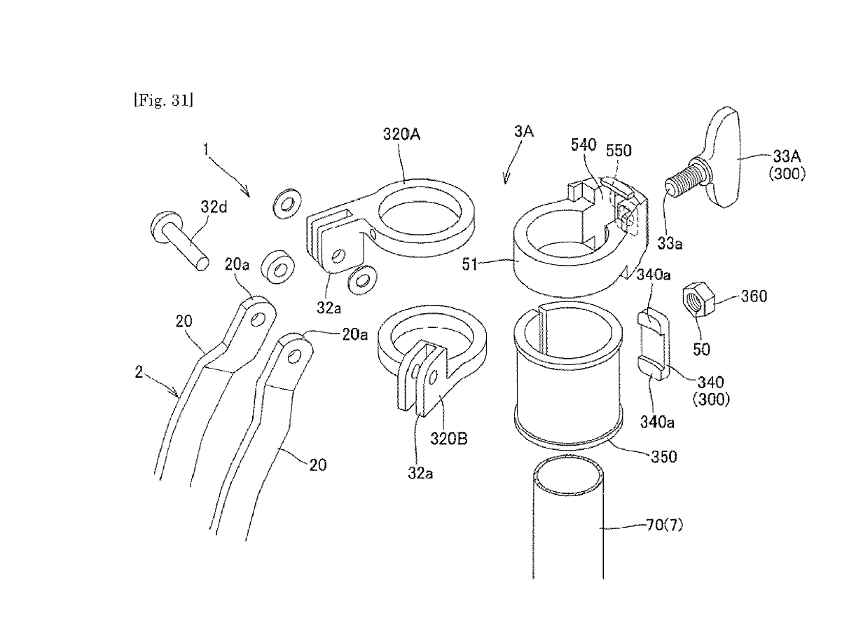

The example shown in FIGS. 30 and 31 is configured such that: only one exterior part 51 is provided; the groove part 540 opened on the inner peripheral side is formed by a groove part with which the nut 360 is engaged so as to be incapable of rotating and a vertically long groove part on the inner peripheral side communicating with the former groove part; and the press member 340 almost three-side square-shaped in a vertical cross-sectional view with the protrusions 340a for pressing the outer peripheral surfaces of the support members 320A and 320B located on the upper and lower sides of the exterior part 51, intervenes in the longitudinally longer groove part. When the fastening screw 33A is fastened, the screw tip end part 33a of the fastening screw 33A protruding from the female screw part 50 toward the lower pipe 70 presses the support members 320A and 320B via the press member 340 against the outer peripheral surface of the lower pipe 70 and fixes the support members 320A and 320B so as to be incapable of turning, and the exterior parts 51 moves in the direction toward the base end of the fastening screw 33A, and abuts and stops on the outer peripheral surface of the lower pipe 70. In this example, the spacer member 350 is provided with flange parts at the upper and lower ends to sandwich the support members 320A and 320B between the flange parts. Alternatively, the spacer member 350 may be structured in another form, for example, in which a pin and a groove engaging in the axial direction are provided between the support members 320A and 320B and the exterior part 51.

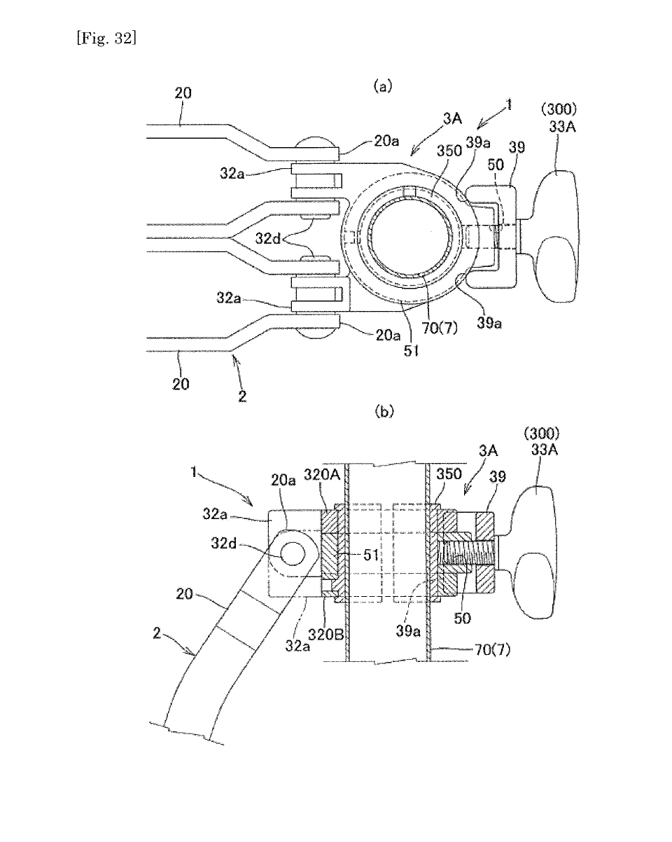

The example shown in FIG. 32 is configured such that: only one exterior part 51 is provided; a press member 39 almost three-side square-shaped in a plan view with vertically long protrusions 39a on right and left end parts thereof for pressing the outer peripheral surfaces of the support members 320A and 320B arranged on the upper and lower sides of the exterior part 51 and a through hole through which the fastening screw 33A penetrates from outside to inside, is engaged on the outside so as to cover a convex part of the exterior part 51 with the female screw part 50; and the fastening screw 33A is provided to penetrate through the through hole in the press member 39 from outside such that the head part of the screw is locked at a part of the press member 39 around the through hole on the outer peripheral surface and the tip end side of the screw is screwed into the female screw part 50. When the fastening screw 33A is fastened, the head part of the fastening screw 33A presses the support members 320A and 320B via the press member 39 against the outer peripheral surface of the lower pipe 70 and fixes the support members 320A and 320B so as to be incapable of turning, and the exterior part 51 moves in the direction toward the base end (the head part) of the fastening screw 33A, and abuts and stops on the outer peripheral surface of the lower pipe 70. In this example, the spacer member 350 is also provided with flange parts at the upper and lower ends to sandwich the support members 320A and 320B between the flange parts. Alternatively, the spacer member 350 may be structured in another form, for example, in which a pin and a groove engaging in the axial direction are provided between the support members 320A and 320B and the exterior part 51.

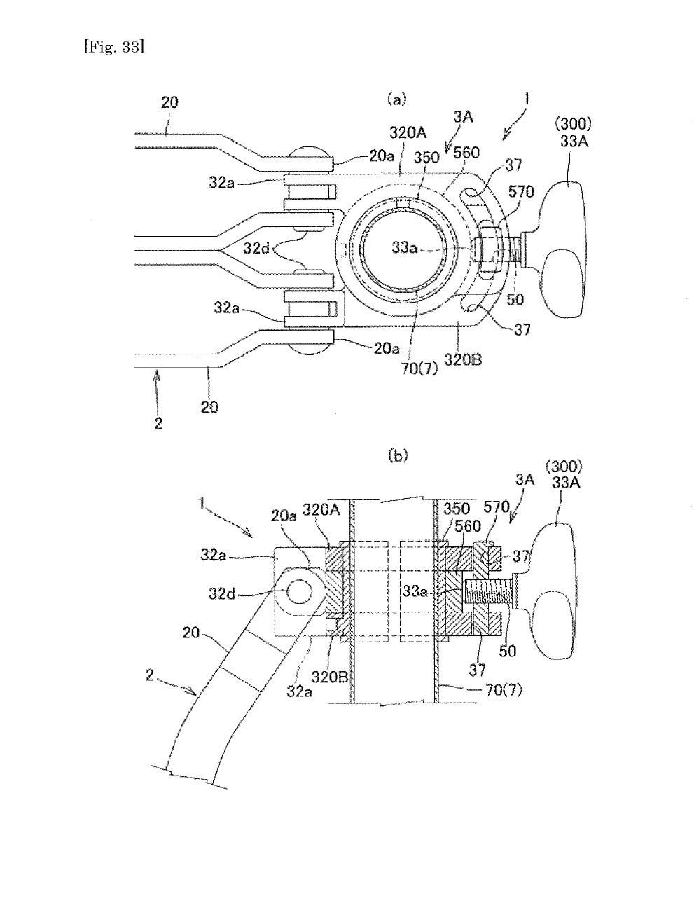

Another example of the fixing member 310, as shown in FIG. 33, is formed separately by an annular exterior member 560 externally attached to the stand main body 7 (lower pipe 70) and a lock member 570 having at an approximately center position the female screw part 50 into which the fastening screw 33A is screwed. In addition, the fixing member 310 may be structured such that: the support members 320A and 320B are concentrically attached on the upper and lower sides of the exterior member 560 externally attached to the lower pipe 70; the support members 320A and 320B are provided with elongated holes 37 penetrating through the lower pipe 70 in the axial direction and extended by a predetermined angular range along the circumferential direction of the lower pipe 70; the lock member 570 is inserted into the elongated holes 37 vertically communicating with each other and the fastening screw 33A is screwed into the female screw part 50 from the outside; the penetrating screw tip end part 33a presses the outer peripheral surface of the exterior member 560 directly or via another member, thereby to allow the exterior member 560 to abut and stop on the outer peripheral surface of the lower pipe 70; and the support members 320A and 320B are drawn outward via the lock member 570 and the elongated holes 37, thereby to allow the support members 320A and 320B to abut and stop on the outer peripheral surface of the lower pipe 70 and to be fixed so as to be incapable of turning.

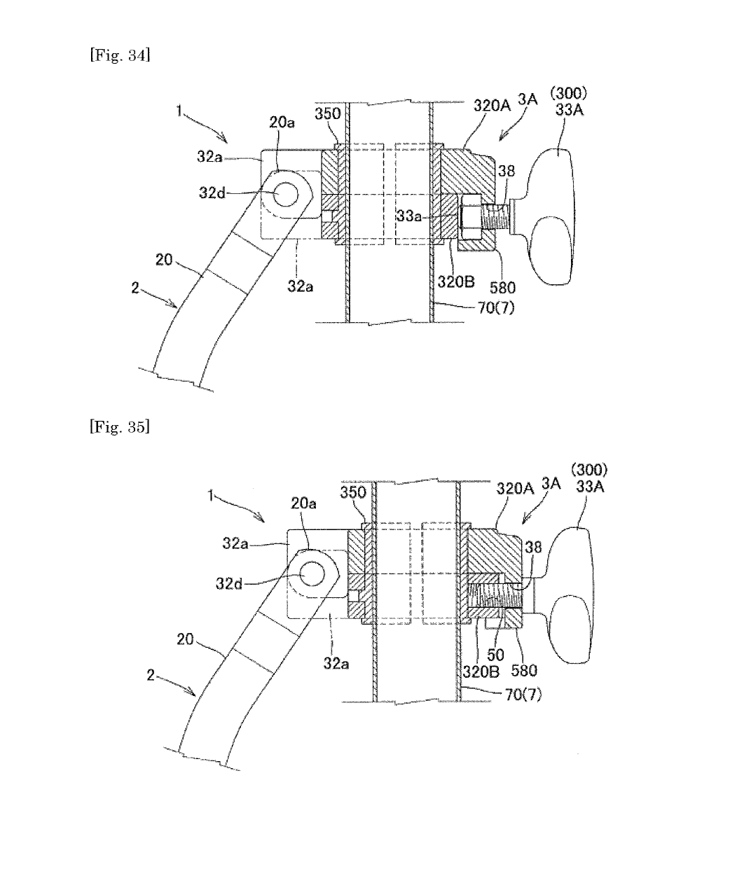

In addition, as shown in FIG. 34 or 35, for example, in a structure in which the fastening screw 33A is screwed into one of the support members 320A and 320B and the support members are pressed or drawn in the axial direction of the fastening screw so as to abut and stop on the outer peripheral surface of the stand main body 7 (lower pipe 70), the fixing member 310 may be omitted. FIG. 34 shows a structure in which the one support member 320A is provided with a convex part 580 extended to a position on the outside of the other support member 320B, the fastening screw 33A is screwed from the outside into the convex part 580 so as to penetrate through the one support member 320A, and when the screw tip end part 33a of the fastening screw 33A presses the outer peripheral surface of the support member 320B directly or via another member, whereby the support member 320B is pressed so as to abut and stop on the outer peripheral surface of the lower pipe 70, and the support member 320A is drawn to the outside and pressed so as to abut and stop on the outer peripheral surface of the lower pipe 70.

FIG. 35 shows a structure in which the one support member 320A is also provided with the convex part 580 extended to a position on the outside of the other support member 320B, the convex part 580 is provided with an elongated hole 38 that is extended by a predetermined angular range along the circumferential direction of the lower pipe 70, the fastening screw 33A penetrating the elongated hole 38 from outside to inside, the other support member 320B is provided with a female screw part 50 opened on the outer peripheral surface, the fastening screw 33A penetrates from the outside the elongated hole 38 in the convex part 580 and has a head part locked around an opening of the elongated hole 38 on the outer peripheral surface of the convex part 580 of the support member 320A and has a tip end side screwed into the female screw part 50, whereby the support member 320A is pressed so as to abut and stop on the outer peripheral surface of the lower pipe 70 via the head part of the fastening screw 33A and the convex part 580, and the support member 320B is drawn to the outside and pressed so as to abut and stop on the outer peripheral surface of the lower pipe 70.

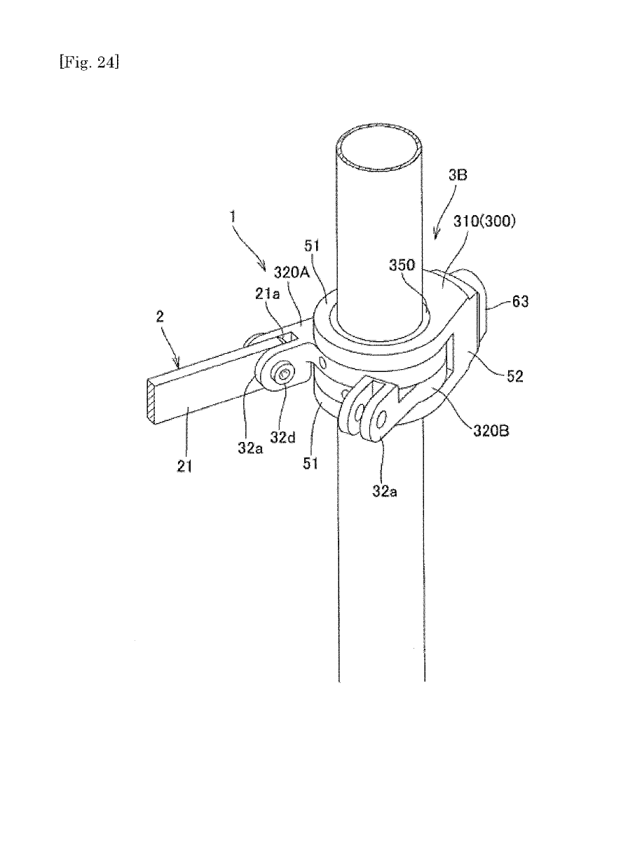

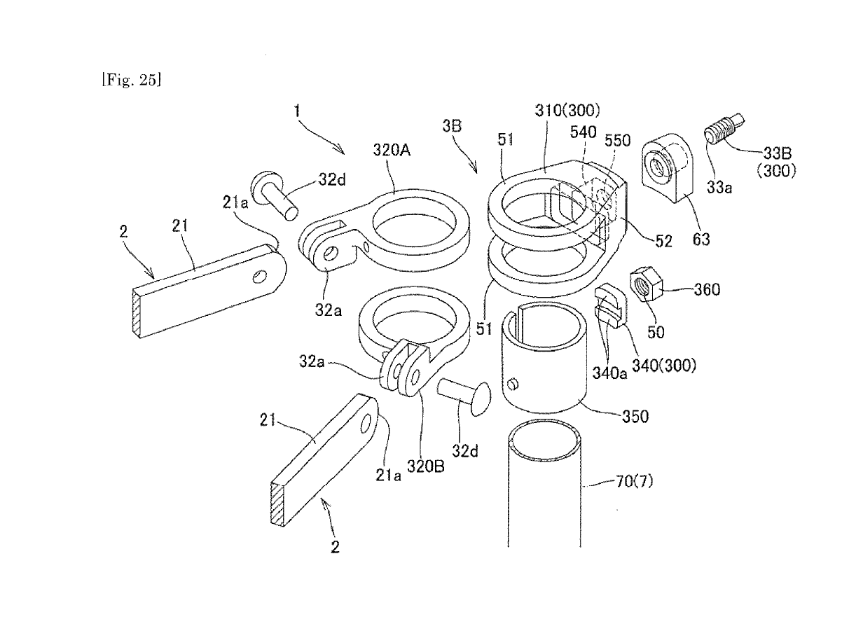

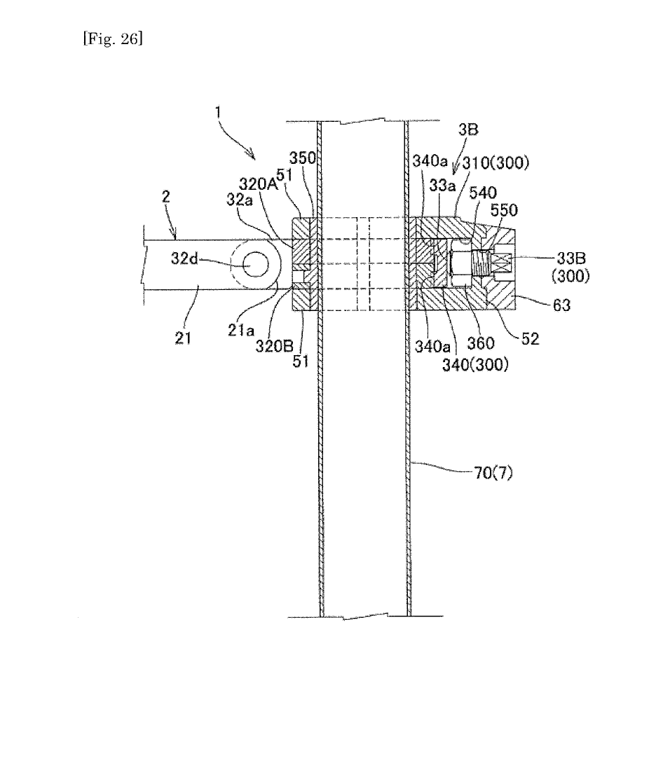

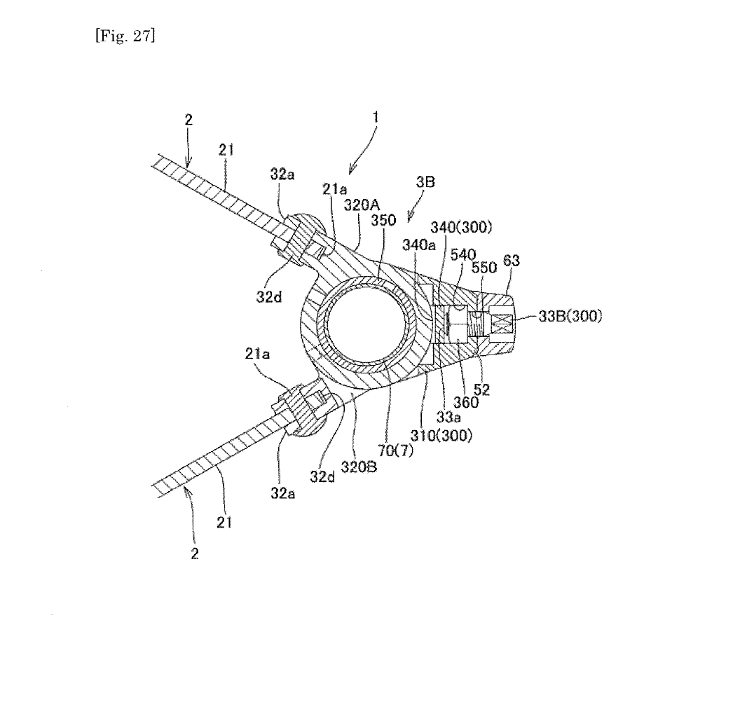

As shown in FIGS. 24 to 27, the second support fitting 3B includes the concentric support members 320A and 320B that are attached to the outer periphery of the lower pipe 70 of the stand main body 7 so as to be capable of turning from side to side around the central axis of the lower pipe 70, and the fixing means 300 formed by the fixing member 310 and the fastening screw 33B. As in the case of the first support fitting 3A, when the fastening screw 33B is operated to adjust the turning angles (fixed positions) of the support members 320A and 320B with respect to the lower pipe 70, it is possible to adjust the side-to-side turning positions of the stand legs 2 around the axis of the lower pipe 70. However, unlike the first support fitting 3A, the second support fitting 3B is incapable of sliding in the direction along the axis of the lower pipe 70, that is, is fixed at the vertical position.

The fastening screw 33B is not a thumbscrew but a bolt operated by a dedicated tool, and has therearound the protective cover 63 made of rubber or synthetic resin elastomer or the like to protect the bolt such that the folded pedal does not hit the head of the bolt. Other configurations and modification examples of the second support fitting 3B are almost the same as those of the first support fitting 3A, and thus the same components are given the same reference numerals and descriptions thereof are omitted.

To adjust the positions of the stand legs 2, both the fastening screw 33A of the first support fitting 3A and the fastening screw 33B of the second support fitting 3B are loosened to turn both of the support members 320A and 320B from side to side by the same amount, and once the positions of the two stand legs 2 are decided, the both fastening screw 33A and 33B are fastened to fix the stand legs 2. To fold the leg device 1, only the fastening screw 33A of the first support fitting 3A is loosened and the support fitting 3A is slid upward to fold the stand legs, as shown in FIG. 36. At that time, the horizontal positions of the stand legs remain fixed by the second support fitting 3B so that the stand legs can be set at the same positions for the next use.

In this example, the support fitting 3A and the 3B are almost the same in structure but may have different structures, that is, one or both may be structured as in the modification examples or in any other manner. In addition, the support fittings 3A and 3B of this example are both attached to the lower pipe 70 constituting the stand main body 7. Alternatively, as a matter of course, one or both may be attached to another member (intermediate pipe or the like) constituting the stand main body.

As in the foregoing, embodiments of the present invention are described. However, the present invention is not limited to the foregoing embodiments but as a matter of course, the present invention can be carried out in various modes without deviating from the gist of the present invention.

### REFERENCE SIGNS LIST

1 Leg device
2 Stand leg
2a End part
3A and 3B Support fitting
4 Pedal device
7 Stand main body
20 Support leg
20a End part
21 Connecting stay
21a End part
30 Support fitting main body
30a Outer peripheral part
30b Inner peripheral surface
31 Stopper member
31a Bearing part
31b Stopper part
32 Connection member
32a Bearing part
32b Shaft part
32c Penetration hole
32d Shaft
33a Tip end part
34 Nut
35 Press member
36 Backing plate
37 Elongated hole
38 Elongated hole
39 Press member
39a Protrusion
40 Support frame
40b Support column
40c Engagement hole
41 Pedal
41a Heel part
42 Connection frame
43 Main frame
44 Branched piece
44a Engagement protrusion
44b Elongated hole
45 Transfer member
46 Fixing screw
50 Female screw part
51 Exterior part
52 Connection part
53 Pin
54 Support member
55 Bearing part
55a Annular support part
56 Screw hole
57 Groove part
58 Through hole
59 Slit groove
60 Close-attachment piece
61 Support base
62 Spacer protrusion
63 Protective cover
70 Lower pipe
71 Upper pipe
72 Up/down rod
73 Cymbal receiver
74 Cymbal holder
76 Tension adjustment device
80 Lower cymbal
81 Upper cymbal
300 Fixing means
310 Fixing member
320A and 320B Support member
340 Press member
340a Protrusion
350 Spacer member
360 Nut
530 Latch part
540 Groove part
550 Through hole
560 Exterior member
570 Lock member
580 Convex part
H High-hat stand

1. A leg device in a musical instrument stand comprising two or more stand legs extended from a stand main body to a floor surface and support fittings that attach the stand legs to the stand main body so as to be foldable, and supporting the stand main body together with a pedal device connected to a lower end of the stand main body, wherein
the support fittings each include:
a support fitting main body attached to an outer peripheral surface of the stand main body so as to be capable of turning from side to side around an axis of the stand main body; and
a connection member having one end portion pivotally attached to an outer peripheral part of the support fitting main body so as to be capable of turning from side to side around an axis parallel to the axis of the stand main body and having a bearing part at the other end portion thereof to which an end portion of the stand leg is pivotally attached so as to be capable of turning up and down around an axis orthogonal to the axis of the stand main body, and wherein
a turning angle of the support fitting main body with respect to the stand main body and a turning angle of the connection member with respect to the support fitting main body are adjusted, thereby to allow adjustments of both side-to-side turning positions of the stand legs pivotally attached to the connection member around the axis of the stand main body and side-to-side turning angles of the stand legs around the axis of the outer peripheral part of the support fitting main body.

2. The leg device in a musical instrument stand according to claim 1, wherein
the support fitting main body includes:
at an outer peripheral part thereof a bearing part supporting a shaft part provided at the one end part of the connection member and extended parallel to the axis of the stand main body so as to be capable of turning from side to side, and a support member with a screw hole penetrating an inner peripheral surface side toward an axial center of the stand main body;
a fastening screw that is screwed into the screw hole in the support member and has a penetrating screw tip end pressing the outer peripheral surface of the stand main body directly or via the press member; and
a stopper member that has a bearing part opposed to the bearing part of the support member and receiving and supporting the shaft part of the connection member so as to be capable of turning from side to side together with the bearing part of the support member and has a stopper part at least in a position opposite to the fastening screw with respect to the stand main body to abut and stop on the outer peripheral surface of the stand main body directly or via the press member, and wherein
when the fastening screw is fastened to press the outer peripheral surface of the stand main body, the support member moves in a direction toward the fastening screw and the bearing part of the support member draws the shaft part of the connection member in that direction, and at the same time, the bearing part of the stopper member supporting the shaft part is also drawn in that direction and the stopper part abuts and stops on the outer peripheral surface of the stand main body directly or via the press member, whereby the shaft part is fixed so as to be incapable of turning by a drawing force of the support member acting on the shaft part and a resistive force of the stopper member in the opposite direction, and a pressing force of the fastening screw tip end and a stopping force of the stopper part of the stopper member act on the outer peripheral surface of the stand main body directly or via the press member, whereby the support fitting main body is fixed so as to be incapable of turning.

3. The leg device in a musical instrument stand according to claim 2, wherein the support fitting main body is attached to the outer peripheral surface of the stand main body so as to be slidable in an axial direction, and when the fastening screw is fastened to press the outer peripheral surface of the stand main body, the support fitting main body is fixed so as to be incapable of rotating and fixed so as to be incapable of sliding in the axial direction.

4. The leg device in a musical instrument stand according to claim 1, wherein
the stand leg includes a support leg that has a lower end placed on the floor surface and an upper end attached to the stand main body, and a connecting stay that has one end connected to a middle part of the support leg and the other end attached to the stand main body at a position lower than the upper end of the support leg,
the support fittings are provided at two places along the axial direction of the stand main body,
of these support fittings, an upper first support fitting is slidable along the axial direction of the stand main body,
the support leg is attached to the first support fitting,
the connecting stay is attached to a lower second support fitting, and
when the first support fitting is slid upward, the stand legs enter into a folded posture along the stand main body.

5. A leg device in a musical instrument stand comprising two or more stand legs extended from a stand main body to a floor surface and support fittings that attach the stand legs to the stand main body so as to be foldable, and supporting the stand main body together with a pedal device connected to a lower end of the stand main body, wherein
the support fittings each include:
two or more concentric support members that are attached to the outer periphery of the stand main body so as to be capable of turning from side to side around the axis of the stand main body and have at an outer peripheral parts thereof bearing parts to which end parts of the stand legs are pivotally attached so as to be capable of turning up and down around an axis orthogonal to the axis of the stand main body; and
a fixing means that, by fastening the fastening screw screwed into one support member of the support members or a fixing member other than the support members, presses or draws the support members in the axis direction of the fastening screw so as to abut and stop on the outer peripheral surface of the stand main body, thereby to fix the fixing members so as to be incapable of turning, and wherein
turning angles of the support members with respect to the stand main body are adjusted to allow adjustments of side-to-side turning positions of the stand legs pivotally attached to the support members around the axis of the stand main body.

6. The leg device in a musical instrument stand according to claim 5, wherein
as the fixing member, a member having an annular exterior part to be externally attached to the stand main body is provided, and
by fastening the fastening screw, the fixing member is drawn or pressed in a direction opposite to the support member along the axial direction of the fastening screw so as to abut and stop on the outer peripheral surface of the stand main body, thereby to fix the fixing member so as to be incapable of turning.

7. The leg device in a musical instrument stand according to claim 6, wherein
the fixing member includes the exterior part and a female screw part to which the fastening screw is screwed,
the two or more support members are concentrically arranged adjacent to the exterior part of the fixing member, and
by fastening the fastening screw screwed into the female screw part, the fastening screw presses the outer peripheral surfaces of the support members directly or via another member, whereby the support members are pressed on the outer peripheral surface of the stand main body and fixed so as to be incapable of turning, the fixing member moves in a direction toward a base end of the fastening screw with an operation part, and the exterior part is drawn in that direction and abuts and stops on the outer peripheral surface of the stand main body directly or via another member, whereby the fixing member is fixed so as to be incapable of turning with respect to the stand main body.

8. The leg device in a musical instrument stand according to claim 7, wherein the female screw part is provided in a penetrating state, and by fastening the fastening screw screwed into the female screw part, a screw tip end part of the fastening screw protruding from the female screw part toward the stand main body presses the outer peripheral surfaces of the support members directly or via another member, whereby the support members are pressed on the peripheral surface of the stand main body and fixed so as to be incapable of turning, and the fixing member moves in the direction toward the base end of the fastening screw, and the exterior part is drawn in that direction and abuts and stops on the outer peripheral surface of the stand main body directly or via another member.

9. The leg device in a musical instrument stand according to claim 8, wherein
the fixing member is almost three-side square-shaped in a vertical cross-sectional view and has a pair of upper and lower annular exterior parts externally attached to the stand main body and a connection part at which the exterior parts are connected and integrated with a space opened in the axial direction on the outside of the stand main body, the connection part being provided with the female screw part, the two or more support members are concentrically arranged in the space between the exterior parts of the fixing member, and
by fastening the fastening screw screwed into the female screw part, the screw tip end part of the fastening screw protruding from the female screw part toward the stand main body presses the outer peripheral surfaces of the support members directly or via another member, whereby the support members are pressed against the outer peripheral surfaces of the stand main body and fixed so as to be incapable of turning, and the fixing member moves in the direction toward the base end of the fastening screw, and the exterior parts are drawn in that direction and abut and stop on the outer peripheral surface of the stand main body directly or via another member.

10. The leg device in a musical instrument stand according to claim 6, wherein the exterior parts of the fixing member are provided so as to be slidable in the axial direction with respect to the stand main body, and by fastening the fastening screw, the fixing member is drawn or pressed in the opposite direction of the support members along the axial direction of the fastening screw and abuts and stops on the outer peripheral surface of the stand main body, whereby the fixing member is fixed so as to be incapable of turning and incapable of sliding in the axial direction.

11. The leg device in a musical instrument stand according to claim 5, wherein
the stand leg includes a support leg that has a lower end placed on the floor surface and an upper end attached to the stand main body and a connecting stay that has one end connected to a middle part of the support leg and the other end attached to the stand main body at a position lower than the upper end of the support leg,
the support fittings are provided at two places along the axial direction of the stand main body, and
of the support fittings, an upper first support fitting is slidable in the axial direction of the stand main body, the support leg is attached to the first support fitting,
the connecting stay is attached to a lower second support fitting, and
when the first support fitting is slid upward, the stand leg enters into a folded posture along the stand main body.

12. A musical instrument stand including the leg device according to claim 1.

13. A support fitting for use in the leg device according to claim 1, including the support fitting main body and the connection member, wherein
the turning angle of the support fitting main body with respect to the stand main body and the turning angle of the connection member with respect to the support fitting main body are adjusted to allow adjustments of both the side-to-side turning positions of the stand legs pivotally attached to the connection members around the axis of the stand main body and the side-to-side turning angle of the support fitting main body around the axis at the outer peripheral part.

14. A support fitting for use in the leg device according to claim 5, including the two or more concentric support members and the foregoing fixing means, wherein
the turning angles of the support members with respect to the stand main body are adjusted to allow adjustments of the side-to-side positions of the stand legs pivotally attached to the support members around the axis of the stand main body.
